(19) United States
(12) Patent Application Publication
(10) Pub. No.: US 2025/0211385 A1
(43) Pub. Date: Jun. 26, 2025

(54) HYBRID AUTOMATIC REPEAT REQUEST (HARQ) DESIGNS FOR PROBABILISTIC AMPLITUDE SHAPING

(71) Applicant: QUALCOMM Incorporated, San Diego, CA (US)

(72) Inventors: Liangming WU, Beijing (CN); Kexin XIAO, Shanghai (CN); Changlong XU, Beijing (CN); Wei LIU, Beijing (CN)

(21) Appl. No.: 18/848,836

(22) PCT Filed: May 16, 2022
(86) PCT No.: PCT/CN2022/092965

§ 371 Date: Sep. 19, 2024

(51) Int. Cl. H04L 5/00; H04L 1/1812; H04L 1/1867

(52) U.S. Cl. CPC H04L 5/0046; H04L 1/1812; H04L 1/1874

(57) ABSTRACT

This disclosure provides systems, methods and apparatus, including computer programs encoded on computer storage media, for hybrid automatic repeat request (HARQ) designs for probabilistic amplitude shaping (PAS). In some aspects, a device may construct a first buffer including a set of shaped bits and a second buffer including a set of non-shaped bits, the first buffer including a first set of shaped information bits and the second buffer including a second set of non-shaped information bits and a set of non-shaped parity bits. The device may transmit a first instance of a data message using a complete set bits from the first buffer and a first subset of bits from the second buffer. The device may transmit a second instance of the data message using at least one of a subset of bits from the first buffer or a second subset of bits from the second buffer.

### CROSS REFERENCE

The present Application is a 371 national stage filing of International PCT Application No. PCT/CN2022/092965 by W U et al. entitled “HYBRID AUTOMATIC REPEAT REQUEST (HARQ) DESIGNS FOR PROBABILISTIC AMPLITUDE SHAPING,” filed May 16, 2022, which is assigned to the assignee hereof, and which is expressly incorporated by reference in its entirety herein.

### TECHNICAL FIELD

This disclosure relates to wireless communications, including hybrid automatic repeat request (HARQ) designs for probabilistic amplitude shaping (PAS).

### DESCRIPTION OF THE RELATED TECHNOLOGY

Wireless communications systems are widely deployed to provide various types of communication content such as voice, video, packet data, messaging, broadcast, and so on. These systems may be capable of supporting communication with multiple users by sharing the available system resources (such as time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations (BSs) or one or more network access nodes, each simultaneously supporting communication for multiple communication devices, which may be otherwise known as user equipment (UE).

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communications. The method may include transmitting a first instance of a data message, where the first instance of the data message is associated with a first set of shaped bits and a first set of non-shaped bits, and transmitting a second instance of the data message as a retransmission of the data message, where the second instance of the data message is associated with at least one of a second set of shaped bits or a second set of non-shaped bits, and where the second set of shaped bits and the second set of non-shaped bits are different from the first set of shaped bits and the first set of non-shaped bits, respectively.

Another innovative aspect of the subject matter described in this disclosure can be implemented in an apparatus for wireless communications. The apparatus may include an interface and a processing system. The interface may be configured to output a first instance of a data message, where the first instance of the data message is associated with a first set of shaped bits and a first set of non-shaped bits, and output a second instance of the data message as a retransmission of the data message, where the second instance of the data message is associated with at least one of a second set of shaped bits or a second set of non-shaped bits, and where the second set of shaped bits and the second set of non-shaped bits are different from the first set of shaped bits and the first set of non-shaped bits, respectively.

Another innovative aspect of the subject matter described in this disclosure can be implemented in an apparatus for wireless communications. The apparatus may include a processor, memory coupled with the processor, and instructions stored in the memory. The instructions may be executable by the processor to cause the apparatus to transmit a first instance of a data message, where the first instance of the data message is associated with a first set of shaped bits and a first set of non-shaped bits, and transmit a second instance of the data message as a retransmission of the data message, where the second instance of the data message is associated with at least one of a second set of shaped bits or a second set of non-shaped bits, and where the second set of shaped bits and the second set of non-shaped bits are different from the first set of shaped bits and the first set of non-shaped bits, respectively.

Another innovative aspect of the subject matter described in this disclosure can be implemented in another apparatus for wireless communications. The apparatus may include means for transmitting a first instance of a data message, where the first instance of the data message is associated with a first set of shaped bits and a first set of non-shaped bits, and means for transmitting a second instance of the data message as a retransmission of the data message, where the second instance of the data message is associated with at least one of a second set of shaped bits or a second set of non-shaped bits, and where the second set of shaped bits and the second set of non-shaped bits are different from the first set of shaped bits and the first set of non-shaped bits, respectively.

Another innovative aspect of the subject matter described in this disclosure can be implemented in a non-transitory computer-readable medium storing code for wireless communications. The code may include instructions executable by a processor to transmit a first instance of a data message, where the first instance of the data message is associated with a first set of shaped bits and a first set of non-shaped bits, and transmit a second instance of the data message as a retransmission of the data message, where the second instance of the data message is associated with at least one of a second set of shaped bits or a second set of non-shaped bits, and where the second set of shaped bits and the second set of non-shaped bits are different from the first set of shaped bits and the first set of non-shaped bits, respectively.

In some implementations of the method, apparatuses, and non-transitory computer-readable medium described herein, the first set of shaped bits of the first instance of the data message corresponds to a complete set of shaped bits from a first buffer and the second set of shaped bits of the second instance of the data message corresponds to a subset of shaped bits of the complete set of shaped bits from the first buffer, and the first set of non-shaped bits of the first instance of the data message corresponds to a first subset of non-shaped bits from a second buffer and the second set of non-shaped bits of the second instance of the data message corresponds to a second subset of non-shaped bits from the second buffer.

In some implementations of the method, apparatuses, and non-transitory computer-readable medium described herein, the first set of shaped bits may be associated with a first starting position of the first buffer and the second set of shaped bits may be associated with a second starting position of the first buffer, and the first set of non-shaped bits may be associated with a first starting position of the second buffer and the second set of non-shaped bits may be associated with a second starting position of the second buffer.

Some implementations of the method, apparatuses, and non-transitory computer-readable medium described herein may further include operations, features, means, or instructions for receiving, via a control message, an indication of a coding rate and a block length for the first instance of the data message, where the second starting position of the second set of shaped bits, a quantity of the second set of shaped bits, the second starting position of the second set of non-shaped bits, and a quantity of the second set of non-shaped bits may be associated with the coding rate and the block length for the first instance of the data message.

One innovative aspect of the subject matter described in this disclosure can be implemented in a method for wireless communications. The method may include receiving a first instance of a data message, where the first instance of the data message is associated with a first set of shaped bits and a first set of non-shaped bits, and receiving a second instance of the data message as a retransmission of the data message, where the second instance of the data message is associated with at least one of a second set of shaped bits or a second set of non-shaped bits, and where the second set of shaped bits and the second set of non-shaped bits are different from the first set of shaped bits and the first set of non-shaped bits, respectively.

Another innovative aspect of the subject matter described in this disclosure can be implemented in an apparatus for wireless communications. The apparatus may include an interface and a processing system. The interface may be configured to obtain a first instance of a data message, where the first instance of the data message is associated with a first set of shaped bits and a first set of non-shaped bits, and obtain a second instance of the data message as a retransmission of the data message, where the second instance of the data message is associated with at least one of a second set of shaped bits or a second set of non-shaped bits, and where the second set of shaped bits and the second set of non-shaped bits are different from the first set of shaped bits and the first set of non-shaped bits, respectively.

Another innovative aspect of the subject matter described in this disclosure can be implemented in an apparatus for wireless communications. The apparatus may include a processor, memory coupled with the processor, and instructions stored in the memory. The instructions may be executable by the processor to cause the apparatus to receive a first instance of a data message, where the first instance of the data message is associated with a first set of shaped bits and a first set of non-shaped bits, and receive a second instance of the data message as a retransmission of the data message, where the second instance of the data message is associated with at least one of a second set of shaped bits or a second set of non-shaped bits, and where the second set of shaped bits and the second set of non-shaped bits are different from the first set of shaped bits and the first set of non-shaped bits, respectively.

Another innovative aspect of the subject matter described in this disclosure can be implemented in another apparatus for wireless communications. The apparatus may include means for receiving a first instance of a data message, where the first instance of the data message is associated with a first set of shaped bits and a first set of non-shaped bits, and means for receiving a second instance of the data message as a retransmission of the data message, where the second instance of the data message is associated with at least one of a second set of shaped bits or a second set of non-shaped bits, and where the second set of shaped bits and the second set of non-shaped bits are different from the first set of shaped bits and the first set of non-shaped bits, respectively.

Another innovative aspect of the subject matter described in this disclosure can be implemented in a non-transitory computer-readable medium storing code for wireless communications. The code may include instructions executable by a processor to receive a first instance of a data message, where the first instance of the data message is associated with a first set of shaped bits and a first set of non-shaped bits, and receive a second instance of the data message as a retransmission of the data message, where the second instance of the data message is associated with at least one of a second set of shaped bits or a second set of non-shaped bits, and where the second set of shaped bits and the second set of non-shaped bits are different from the first set of shaped bits and the first set of non-shaped bits, respectively.

In some implementations of the method, apparatuses, and non-transitory computer-readable medium described herein, the first set of shaped bits of the first instance of the data message may be associated with a first starting position and an entirety of a set of multiple shaped bits and the second set of shaped bits of the second instance of the data message may be associated with a second starting position and a subset of the set of multiple shaped bits, and the first set of non-shaped bits of the first instance of the data message may be associated with a first starting position and a first subset of a set of multiple non-shaped bits and the second set of non-shaped bits of the second instance of the data message may be associated with a second starting position and a second subset of the set of multiple non-shaped bits.

Some implementations of the method, apparatuses, and non-transitory computer-readable medium described herein may further include operations, features, means, or instructions for transmitting, via a control message, an indication of a coding rate and a block length for the first instance of the data message, where the second starting position of the second set of shaped bits, a quantity of the second set of shaped bits, the second starting position of the second set of non-shaped bits, and a quantity of the second set of non-shaped bits may be associated with the coding rate and the block length for the first instance of the data message.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows an example wireless communications system that supports hybrid automatic repeat request (HARQ) designs for probabilistic amplitude shaping (PAS).

FIG. 2 shows an example signaling diagram that supports HARQ designs for PAS.

FIGS. 3 and 4 show example read operations that support HARQ designs for PAS.

FIG. 5 shows an example PAS communication diagram that supports HARQ designs for PAS.

FIG. 6 shows an example buffer that supports HARQ designs for PAS.

FIG. 7 shows an example process flow that supports HARQ designs for PAS.

FIGS. 8 and 9 show block diagrams of example devices that support HARQ designs for PAS.

FIGS. 10 and 11 show flowcharts illustrating example methods that support HARQ designs for PAS.

Like reference numbers and designations in the various drawings indicate like elements.

### DETAILED DESCRIPTION

The following description is directed to some implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving radio frequency (RF) signals according to any of the Institute of Electrical and Electronics Engineers (IEEE) 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IoT) network, such as a system utilizing third generation (3G), fourth generation (4G) or fifth generation (5G), or further implementations thereof, technology.

In some wireless communications systems, a first device may select a constellation point within a modulation scheme to modulate a set of information bits onto a carrier frequency for transmission to a second device. The first device may select the constellation point from a set of constellation points associated with the modulation scheme (where each constellation point conveys a different permutation of a given quantity of bits) and, in accordance with some modulation techniques, each constellation point may have approximately the same probability of being selected or used by the first device. Different constellation points may be associated with different amplitudes (and therefore different transmission powers), which may result in the first device having an approximately equal probability of selecting a high transmission power constellation point as selecting a low transmission power constellation point. To increase the probability that the first device selects a relatively low transmission power constellation point, the first device may employ a probabilistic amplitude shaping (PAS) modulation technique according to which constellation points associated with relatively lower transmission powers may have a relatively higher probability of selection by the first device.

In accordance with a PAS modulation technique, the first device may use a distribution matcher to shape a set of input bits. The first device may use the shaped input bits, along with a set of non-shaped bits, to map a bit stream to a respective set of constellation points. For example, the first device may use a first set of shaped information bits to select, ascertain, or otherwise determine an amplitude of a constellation point and may use a set of non-shaped information bits and a set of non-shaped parity bits to select, ascertain, or otherwise determine a sign (such as plus or minus) for the constellation point. As such, the first device may achieve a suitable probability for selecting a low transmission power constellation point (such as a constellation point with a relatively small amplitude) and suitable error detection for an initial transmission. In some PAS designs, however, the first device may be unable to maintain such a suitable probability of selecting a low transmission power constellation point for a retransmission because the first device may use exclusively non-shaped parity bits, or an unspecified portion of information bits (which may be shaped or non-shaped) and non-shaped parity bits, for the retransmission. As such, the first device may lack the ability to intentionally preserve or guarantee a likelihood of selecting a constellation point associated with a relatively small amplitude and low transmission power for the retransmission.

In some implementations, a first device and a second device may support a feedback design for PAS that maintains or preserves a likelihood of selecting a low transmission power constellation point for one or more retransmissions of a data message. For example, the first device may construct and maintain two circular buffers for PAS. In such implementations, the first device may store a set of shaped bits in the first buffer and may store a set of non-shaped bits in the second buffer, where the set of shaped bits may include a first set of information bits associated with the data message and the set of non-shaped bits may include a second set of information bits associated with the data message and a set of parity bits. For a first instance of the data message, the first device may transmit an entirety of the set of shaped bits from the first buffer and a first subset of the set of non-shaped bits from the second buffer. For a second instance of the data message, the first device may transmit at least one of a first subset of the set of shaped bits from the first buffer or a second subset of the set of non-shaped bits from the second buffer. The first device may select, for the second instance of the data message, one or both of the first subset of the set of shaped bits or the second subset of the set of non-shaped bits and which bits to include in each respective subset in accordance with one or both of a coding rate and a block length associated with the data message or a redundancy version associated with the second instance of the data message.

Particular implementations of the subject matter described in this disclosure can be implemented to realize one or more of the following potential advantages. For example, as a result of selecting one or both of the first subset of the set of shaped bits or the second subset of the set of non-shaped bits and which bits to include in each respective subset in accordance with one or both of a coding rate and a block length of the first instance of the data message or a redundancy version of the second instance of the data message, the first device may achieve a balance between shaping gain (such as a likelihood of selecting a low transmission power constellation point) and feedback gain (such as a level of redundancy and a likelihood for the second device to successfully receive and decode the second instance of the data message). In other words, the first device may control the preservation of shaping gain and feedback gain, or a tradeoff between shaping gain and feedback gain, across one or more retransmissions. For example, the first device may control whether to err toward a higher likelihood of selecting a low transmission power constellation point (by including more shaped information bits in the retransmission) or toward a higher likelihood for successful reception by the second device (by including more non-shaped parity bits in the retransmission). Further, and in accordance with such control and balance, the first device may achieve or experience greater power savings, greater spectral efficiency, higher data rates, lower latency, and greater system capacity, among other benefits.

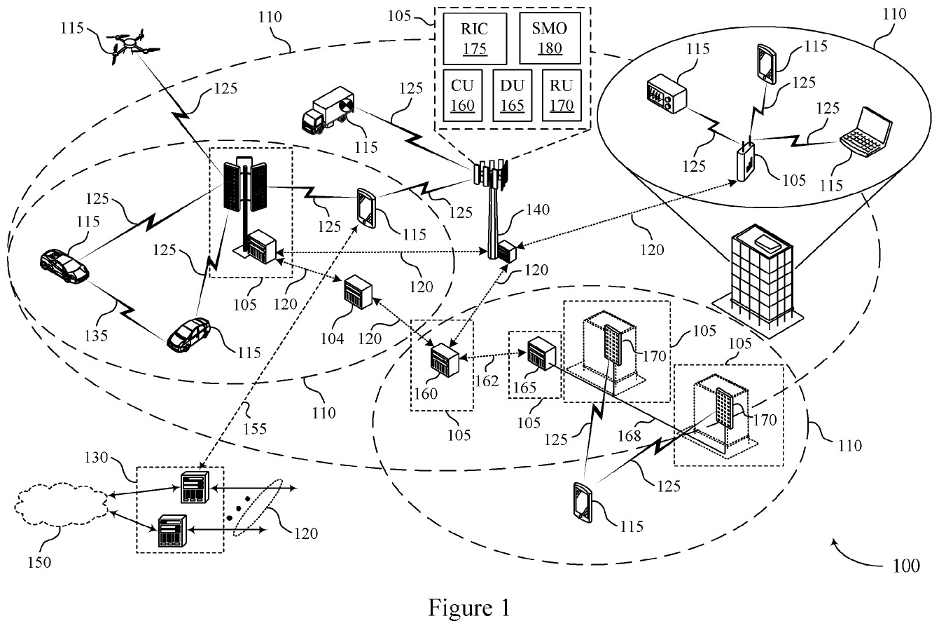

FIG. 1 shows an example of a wireless communications system 100 that supports HARQ designs for PAS. The wireless communications system 100 may include one or more network entities 105, one or more UEs 115, and a core network 130. In some implementations, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some implementations, network entities 105 and UEs 115 may wirelessly communicate via one or more communication links 125 (such as a radio frequency (RF) access link). For example, a network entity 105 may support a coverage area 110 (such as a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (such as any network entity described herein), a UE 115 (such as any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some implementations, network entities 105 may communicate with the core network 130, or with one another, or both. For example, network entities 105 may communicate with the core network 130 via one or more backhaul communication links 120 (such as in accordance with an S1, N2, N3, or other interface protocol). In some implementations, network entities 105 may communicate with one another over a backhaul communication link 120 (such as in accordance with an X2, Xn, or other interface protocol) either directly (such as directly between network entities 105) or indirectly (such as via a core network 130). In some implementations, network entities 105 may communicate with one another via a midhaul communication link 162 (such as in accordance with a midhaul interface protocol) or a fronthaul communication link 168 (such as in accordance with a fronthaul interface protocol), or any combination thereof. The backhaul communication links 120, midhaul communication links 162, or fronthaul communication links 168 may be or include one or more wired links (such as an electrical link, an optical fiber link), one or more wireless links (such as a radio link, a wireless optical link), among other examples or various combinations thereof. A UE 115 may communicate with the core network 130 through a communication link 155.

One or more of the network entities 105 described herein may include or may be referred to as a base station (BS) 140 (such as a base transceiver station, a radio BS, an NR BS, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some implementations, a network entity 105 (such as a BS 140) may be implemented in an aggregated (such as monolithic, standalone) BS architecture, which may be configured to utilize a protocol stack that is physically or logically integrated within a single network entity 105 (such as a single RAN node, such as a BS 140).

In some implementations, a network entity 105 may be implemented in a disaggregated architecture (such as a disaggregated BS architecture, a disaggregated RAN architecture), which may be configured to utilize a protocol stack that is physically or logically distributed among two or more network entities 105, such as an integrated access backhaul (IAB) network, an open RAN (O-RAN) (such as a network configuration sponsored by the O-RAN Alliance), or a virtualized RAN (vRAN) (such as a cloud RAN (C-RAN)). For example, a network entity 105 may include one or more of a central unit (CU) 160, a distributed unit (DU) 165, a radio unit (RU) 170, a RAN Intelligent Controller (RIC) 175 (such as a Near-Real Time RIC (Near-RT RIC), a Non-Real Time RIC (Non-RT RIC)), a Service Management and Orchestration (SMO) 180 system, or any combination thereof. An RU 170 also may be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (such as separate physical locations). In some implementations, one or more network entities 105 of a disaggregated RAN architecture may be implemented as virtual units (such as a virtual CU (VCU), a virtual DU (VDU), a virtual RU (VRU)).

The split of functionality between a CU 160, a DU 165, and an RU 170 is flexible and may support different functionalities depending upon which functions (such as network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some implementations, the CU 160 may host upper protocol layer (such as layer 3 (L3), layer 2 (L2)) functionality and signaling (such as Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (such as physical (PHY) layer) or L2 (such as radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (such as via one or more RUs 170). In some implementations, a functional split between a CU 160 and a DU 165, or between a DU 165 and an RU 170 may be within a protocol layer (such as some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (such as F1, F1-c, F1-u), and a DU 165 may be connected to one or more RUs 170 via a fronthaul communication link 168 (such as open fronthaul (FH) interface). In some implementations, a midhaul communication link 162 or a fronthaul communication link 168 may be implemented in accordance with an interface (such as a channel) between layers of a protocol stack supported by respective network entities 105 that are in communication over such communication links.

In wireless communications systems (such as wireless communications system 100), infrastructure and spectral resources for radio access may support wireless backhaul link capabilities to supplement wired backhaul connections, providing an IAB network architecture (such as to a core network 130). In some implementations, in an IAB network, one or more network entities 105 (such as IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (such as a donor BS 140). The one or more donor network entities 105 (such as IAB donors) may be in communication with one or more additional network entities 105 (such as IAB nodes 104) via supported access and backhaul links (such as backhaul communication links 120). IAB nodes 104 may include an IAB mobile termination (IAB-MT) controlled (such as scheduled) by DUs 165 of a coupled IAB donor. An IAB-MT may include an independent set of antennas for relay of communications with UEs 115, or may share the same antennas (such as of an RU 170) of an IAB node 104 used for access via the DU 165 of the IAB node 104 (such as referred to as virtual IAB-MT (VIAB-MT)). In some implementations, the IAB nodes 104 may include DUs 165 that support communication links with additional entities (such as IAB nodes 104, UEs 115) within the relay chain or configuration of the access network (such as downstream). In such implementations, one or more components of the disaggregated RAN architecture (such as one or more IAB nodes 104 or components of IAB nodes 104) may be configured to operate according to the techniques described herein.

For instance, an access network (AN) or RAN may include communications between access nodes (such as an IAB donor), IAB nodes 104, and one or more UEs 115. The IAB donor may facilitate connection between the core network 130 and the AN (such as via a wired or wireless connection to the core network 130). That is, an IAB donor may refer to a RAN node with a wired or wireless connection to core network 130. The IAB donor may include a CU 160 and at least one DU 165 (such as and RU 170), in which implementation the CU 160 may communicate with the core network 130 over an interface (such as a backhaul link). IAB donor and IAB nodes 104 may communicate over an F1 interface according to a protocol that defines signaling messages (such as an F1 AP protocol). Additionally, or alternatively, the CU 160 may communicate with the core network over an interface, which may be an example of a portion of backhaul link, and may communicate with other CUs 160 (such as a CU 160 associated with an alternative IAB donor) over an Xn-C interface, which may be an example of a portion of a backhaul link.

An IAB node 104 may refer to a RAN node that provides IAB functionality (such as access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (such as an IAB donor may relay transmissions for UEs through one or more other IAB nodes 104). Additionally, or alternatively, an IAB node 104 also may be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (such as DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (such as a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (such as transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the implementation of the techniques described herein applied in the context of a disaggregated RAN architecture, one or more components of the disaggregated RAN architecture may be configured to support HARQ designs for PAS as described herein. For example, some operations described as being performed by a UE 115 or a network entity 105 (such as a BS 140) may additionally, or alternatively, be performed by one or more components of the disaggregated RAN architecture (such as IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” also may be referred to as a unit, a station, a terminal, or a client, among other examples. A UE 115 also may include or may be referred to as a personal electronic device such as a cellular phone, a personal digital assistant (PDA), a tablet computer, a laptop computer, or a personal computer. In some implementations, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay BSs, among other examples, as shown in FIG. 1.

The UEs 115 and the network entities 105 may wirelessly communicate with one another via one or more communication links 125 (such as an access link) over one or more carriers. The term “carrier” may refer to a set of RF spectrum resources having a defined physical layer structure for supporting the communication links 125. For example, a carrier used for a communication link 125 may include a portion of a RF spectrum band (such as a bandwidth part (BWP)) that is operated according to one or more physical layer channels for a given radio access technology (such as LTE, LTE-A, LTE-A Pro, NR). Each physical layer channel may carry acquisition signaling (such as synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (such as entity, sub-entity) of a network entity 105. For example, the terms “transmitting,” “receiving,” or “communicating,” when referring to a network entity 105, may refer to any portion of a network entity 105 (such as a BS 140, a CU 160, a DU 165, a RU 170) of a RAN communicating with another device (such as directly or via one or more other network entities 105).

In some implementations, such as in a carrier aggregation configuration, a carrier also may have acquisition signaling or control signaling that coordinates operations for other carriers. A carrier may be associated with a frequency channel (such as an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which implementation initial acquisition and connection may be conducted by the UEs 115 via the carrier, or the carrier may be operated in a non-standalone mode, in which implementation a connection is anchored using a different carrier (such as of the same or a different radio access technology).

The communication links 125 shown in the wireless communications system 100 may include downlink transmissions (such as forward link transmissions) from a network entity 105 to a UE 115, uplink transmissions (such as return link transmissions) from a UE 115 to a network entity 105, or both, among other configurations of transmissions. Carriers may carry downlink or uplink communications (such as in an FDD mode) or may be configured to carry downlink and uplink communications (such as in a TDD mode).

Signal waveforms transmitted over a carrier may be made up of multiple subcarriers (such as using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (such as a duration of one modulation symbol) and one subcarrier, in which implementation the symbol period and subcarrier spacing may be inversely related. The quantity of bits carried by each resource element may depend on the modulation scheme (such as the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (such as a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some implementations, a UE 115 may be configured with multiple BWPs. In some implementations, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (such as 10 milliseconds (ms)). Each radio frame may be identified by a system frame number (SFN) (such as ranging from 0 to 1023).

Each frame may include multiple consecutively numbered subframes or slots, and each subframe or slot may have the same duration. In some implementations, a frame may be divided (such as in the time domain) into subframes, and each subframe may be further divided into a quantity of slots. Alternatively, each frame may include a variable quantity of slots, and the quantity of slots may depend on subcarrier spacing. Each slot may include a quantity of symbol periods (such as depending on the length of the cyclic prefix prepended to each symbol period). In some wireless communications systems 100, a slot may further be divided into multiple mini-slots containing one or more symbols. Excluding the cyclic prefix, each symbol period may contain one or more (such as N_{f}) sampling periods. The duration of a symbol period may depend on the subcarrier spacing or frequency band of operation.

A subframe, a slot, a mini-slot, or a symbol may be the smallest scheduling unit (such as in the time domain) of the wireless communications system 100 and may be referred to as a transmission time interval (TTI). In some implementations, the TTI duration (such as a quantity of symbol periods in a TTI) may be variable. Additionally, or alternatively, the smallest scheduling unit of the wireless communications system 100 may be dynamically selected (such as in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (such as a control resource set (CORESET)) for a physical control channel may be defined by a set of symbol periods and may extend across the system bandwidth or a subset of the system bandwidth of the carrier. One or more control regions (such as CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (such as control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (such as over a carrier) and may be associated with an identifier for distinguishing neighboring cells (such as a physical cell identifier (PCID), a virtual cell identifier (VCID), or others). In some implementations, a cell also may refer to a coverage area 110 or a portion of a coverage area 110 (such as a sector) over which the logical communication entity operates. Such cells may range from smaller areas (such as a structure, a subset of structure) to larger areas depending on various factors such as the capabilities of the network entity 105. For example, a cell may be or include a building, a subset of a building, or exterior spaces between or overlapping with coverage areas 110, among other examples.

In some implementations, a network entity 105 (such as a BS 140, an RU 170) may be movable and therefore provide communication coverage for a moving coverage area 110. In some implementations, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some implementations, a UE 115 may be able to communicate directly with other UEs 115 over a device-to-device (D2D) communication link 135 (such as in accordance with a peer-to-peer (P2P), D2D, or sidelink protocol). In some implementations, one or more UEs 115 of a group that are performing D2D communications may be within the coverage area 110 of a network entity 105 (such as a BS 140, an RU 170), which may support aspects of such D2D communications being configured by or scheduled by the network entity 105. In some implementations, one or more UEs 115 in such a group may be outside the coverage area 110 of a network entity 105 or may be otherwise unable to or not configured to receive transmissions from a network entity 105. In some implementations, groups of the UEs 115 communicating via D2D communications may support a one-to-many (1:M) system in which each UE 115 transmits to each of the other UEs 115 in the group. In some implementations, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (such as a mobility management entity (MME), an access and mobility management function (AMF)) and at least one user plane entity that routes packets or interconnects to external networks (such as a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (such as BSs 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (such as less than 100 kilometers) compared to transmission using the smaller frequencies and longer waves of the high frequency (HF) or very high frequency (VHF) portion of the spectrum below 300 MHz.

The wireless communications system 100 also may operate in a super high frequency (SHF) region using frequency bands from 3 GHz to 30 GHz, also known as the centimeter band, or in an extremely high frequency (EHF) region of the spectrum (such as from 30 GHz to 300 GHz), also known as the millimeter band. In some implementations, the wireless communications system 100 may support millimeter wave (mmW) communications between the UEs 115 and the network entities 105 (such as BSs 140, RUs 170), and EHF antennas of the respective devices may be smaller and more closely spaced than UHF antennas. In some implementations, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some implementations, operations in unlicensed bands may be associated with a carrier aggregation configuration in conjunction with component carriers operating in a licensed band (such as LAA). Operations in unlicensed spectrum may include downlink transmissions, uplink transmissions, P2P transmissions, or D2D transmissions, among other examples.

A network entity 105 (such as a BS 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more BS antennas or antenna arrays may be co-located at an antenna assembly, such as an antenna tower. In some implementations, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (such as the same codeword) or different data streams (such as different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which also may be referred to as spatial filtering, directional transmission, or directional reception, is a signal processing technique that may be used at a transmitting device or a receiving device (such as a network entity 105, a UE 115) to shape or steer an antenna beam (such as a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (such as with respect to the antenna array of the transmitting device or receiving device, or with respect to some other orientation).

The UEs 115 and the network entities 105 may support retransmissions of data to increase the likelihood that data is received successfully. HARQ feedback is one technique for increasing the likelihood that data is received correctly over a communication link (such as a communication link 125, a D2D communication link 135). HARQ may include a combination of error detection (such as using a cyclic redundancy check (CRC)), forward error correction (FEC), and retransmission (such as automatic repeat request (ARQ)). HARQ may improve throughput at the MAC layer in poor radio conditions (such as low signal-to-noise conditions). In some implementations, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some wireless communications systems, such as the wireless communications system 100, a first device (which may be an example of a UE 115 or a network entity 105) may employ a PAS modulation technique to increase a likelihood that the first device selects a constellation point associated with a relatively lower transmission power in a modulation scheme. In accordance with a PAS modulation technique, the first device may use a distribution matcher to shape a set of input bits and the first device may use the shaped input bits, along with a set of non-shaped bits, to map a bit stream to constellation points. For example, the first device may use a first set of shaped information bits to select, ascertain, or otherwise determine an amplitude of a constellation point and may use a set of non-shaped information bits and a set of non-shaped parity bits to select, ascertain, or otherwise determine a sign (such as plus or minus) for the constellation point. As such, the first device may achieve a suitable likelihood for selecting a low transmission power constellation point (such as constellation point associated with a relatively small amplitude) and error detection for an initial transmission. In some PAS designs, however, the first device may be unable to maintain such a suitable likelihood selecting a low transmission power constellation point for a retransmission because the first device may use exclusively non-shaped parity bits, or use an unspecified portion of information bits (which may be shaped or non-shaped) and non-shaped parity bits, for the retransmission. As such, the first device may lack the ability to preserve the likelihood of selecting a low transmission power constellation point.

In some implementations, the first device may support a feedback design for PAS that maintains or preserves a relatively higher likelihood of selecting a relatively lower transmission power constellation point for one or more retransmissions of a data message. For example, the first device may be scheduled to transmit a data message and may use a PAS modulation technique to encode a set of information bits of the data message and to map the encoded information bits to a constellation and, in some implementations, the first device may construct two buffers (such as two circular buffers) to store shaped bits and non-shaped bits. In accordance with the PAS modulation technique, for example, the first device may shape a first set of information bits associated with the data message and may leave a second set of information bits associated with the data message as non-shaped. As such, the first set of shaped information bits may be associated with a non-uniform constellation mapping probability and the second set of non-shaped information bits may be associated with a uniform constellation mapping probability.

The first device may store the first set of shaped information bits in a first of the two buffers and may store the second set of non-shaped information bits, along with a set of non-shaped parity bits, in a second of the two buffers. In some implementations, the first device may transmit a first instance of the data message using a complete set of bits from the first buffer and a first subset of bits from the second buffer. For a second instance of the data message (such as a retransmission of the data message), the first device may transmit at least one of a first subset of bits from the first buffer or a second subset of bits from the second buffer. In some implementations, the first device may select one or both of the first subset of the set of shaped bits or the second subset of the set of non-shaped bits, and which bits to include in each respective subset, in accordance with one or both of a coding rate and a block length associated with the first instance of the data message or a redundancy version associated with the second instance of the data message. As such, the first device may dynamically control how many shaped bits (and which specific shaped bits), if any, and how many non-shaped bits (and which specific non-shaped bits), if any, to include in each of one or more retransmissions of the data message, which may enable the first device to control or favor a preservation of shaping gain or feedback gain, if not both.

Further, as described herein, the first device may construct and maintain a first circular buffer and a second circular buffer. A circular buffer may refer to a buffer in which, for purposes of a reading of the buffer, a first or initial input is proximate to a last or final input. For example, if a circular buffer includes n bits from 0 to n−1, during a read of the buffer, a device may expect that the 0^{th} bit immediately follows the (n−1)^{th} bit.

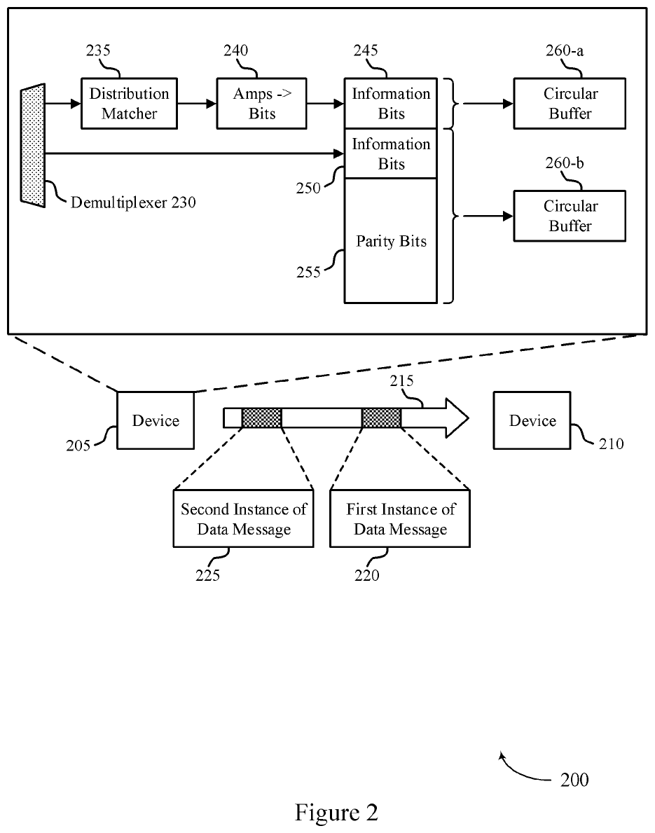

FIG. 2 shows an example signaling diagram 200 that supports HARQ designs for PAS. The signaling diagram 200 may implement or be implemented to realize aspects of the wireless communications system 100. For example, the signaling diagram 200 illustrates communication between a device 205 and a device 210 via a communication link 215. The device 205 may be an example of a UE 115 or a network entity 105 as illustrated by and described with reference to FIG. 1. The device 210 may be an example of a UE 115 or a network entity 105 as illustrated by and described with reference to FIG. 1. The device 205 may employ a PAS modulation technique according to which the device 205 may achieve a greater probability of selecting a relatively lower transmission power constellation point for a data message transmission and, in some implementations, the device 205 may maintain a shaping gain associated with the PAS modulation technique for one or more retransmissions of the data message.

For example, the device 205 may receive (such as from the device 210) scheduling information for a first instance of a data message 220 and, in accordance with a PAS modulation technique, may obtain a shaping gain for the first instance of the data message via a mapping and demapping of a set of information bits associated with the data message to shaped symbols. As described herein, the set of information bits associated with the data message may be referred to as input bits, systemic bits, or a transmission binary. To obtain the shaping gain, the device 205 may input the set of information bits into a demultiplexer 230, obtain, as an output of the demultiplexer 230, a first set of information bits 245 and a second set of information bits 250, and pass the first set of information bits 245 through a distribution matcher 235 and an amps-to-bits block 240.

In some aspects, the device 205 may use the distribution matcher 235 to create or generate a non-uniform constellation mapping probability for the set of information bits 245 (such that the device 205 may have a greater probability of mapping the set of information bits 245 to a relatively smaller amplitude and therefore a relatively lower transmission power constellation point) and the set of information bits 250 may be associated with a uniform constellation mapping probability in accordance with not being passed through the distribution matcher 235. The device 205 may add a set of parity bits 255 to the information bits associated with the data message and, in some aspects, the set of parity bits 255 may be non-shaped bits (and, likewise, may be associated with a uniform constellation mapping probability). As such, the set of information bits 245 may be referred to as a set of shaped bits and the set of information bits 250 and the set of parity bits 255 may be referred to as a set of non-shaped bits.

In some aspects, the device 205 may achieve shaping gain (a greater probability of selecting a relatively lower transmission power constellation point) for the first instance of the data message 220 (an initial transmission of the data message), but not for a retransmission of the data message. For example, a retransmission of the data message may include parity bits from the set of parity bits 255 (which may be non-shaped bits) and exclude information bits or may include a partial set of information bits (only some of which may be shaped) and parity bits. As such, the device 205 may be unable to control or guarantee a shaping gain for a retransmission of the data message.

In some implementations, the device 205 may preserve shaping gain and feedback gain, or be able to control a tradeoff between shaping gain and feedback gain, within a PAS system or modulation technique in accordance with a multi-buffer design associated with the presence of both shaped and non-shaped bits. For example, the device 205 may construct two circular buffers 260, including a circular buffer 260-a and a circular buffer 260-b. As used herein, a circular buffer 260 or circular buffers 260 may refer generally to one or both of the circular buffer 260-a and the circular buffer 260-b. In some implementations, the device 205 may construct the circular buffer 260-a to store, include, or otherwise hold the output bits or symbols from the distribution matcher 235 and may construct the circular buffer 260-b to store, include, or otherwise hold non-shaped information bits and parity bits. In other words, and as illustrated by the signaling diagram 200, the device 205 may store the set of information bits 245 in the circular buffer 260-a and may store the set of information bits 250 and the set of parity bits 255 in the circular buffer 260-b.

The device 205 may support a reading of the circular buffer 260-a and the circular buffer 260-b to preserve shaping gain and feedback gain. In some implementations, for example, the device 205 may perform different read operations (select different sets or quantity of bits) from one or both of the two circular buffers 260 to balance shaping gain and feedback gain and in accordance with various aspects associated with the transmission or retransmission of the data message. In some implementations, the device 205 may transmit the first instance of the data message 220 in accordance with transmitting a complete set of bits from the circular buffer 260-a (such as all bits in the circular buffer 260-a) and a portion (such as a subset) of bits from the circular buffer 260-b. In other words, the device 205 may formulate the transmitted symbols for the first instance of the data message 220 using the complete set of bits from the circular buffer 260-a and using the portion of bits from the circular buffer 260-b.

In some implementations, the device 205 may transmit the second instance of the data message 225 in accordance with transmitting a portion (such as a subset) of the bits in the circular buffer 260-a and a portion of the bits in the circular buffer 260-b. In other words, the device 205 may formulate the transmitted symbols for the second instance of the data message 225 using the portion of bits from the circular buffer 260-a and using the portion of bits from the circular buffer 260-b. In some aspects, the device 205 may use different portions of the circular buffer 260-b for the first instance of the data message 220 and the second instance of the data message 225. Further, a first read length and a first starting position of the circular buffer 260-a and a second read length and a second starting position of the circular buffer 260-b, for one or both of the first instance of the data message 220 or the second instance of the data message 225, may be related to various aspects associated with the data message. For example, the read lengths and starting positions of the two circular buffers 260 (which may be referred to or understood as the read operations of the two circular buffers 260) may be associated with or related to a shaping rate (which may be defined by or associated with a modulation and coding scheme (MCS)), a block length of the first instance of the data message 220, or a coding rate of the first instance of the data message 220.

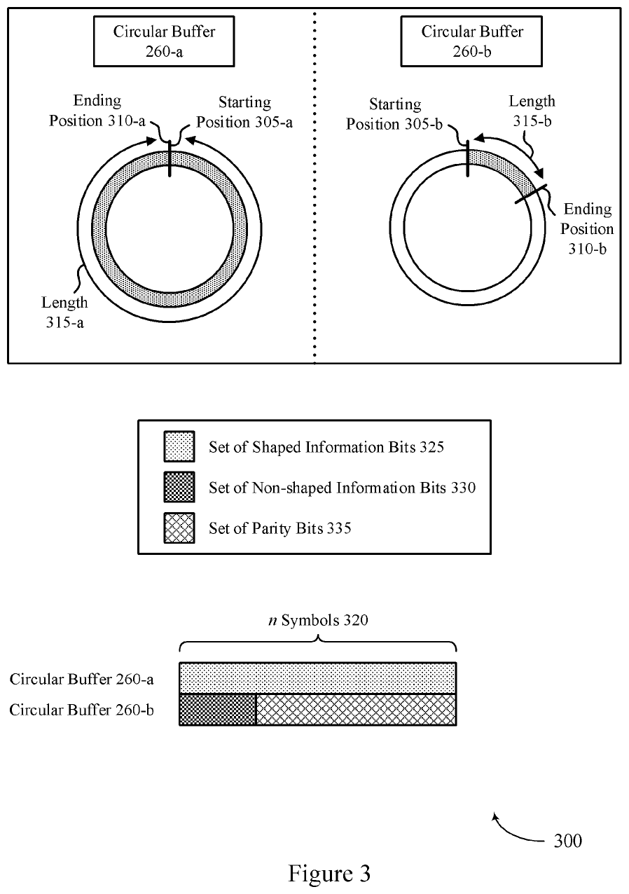

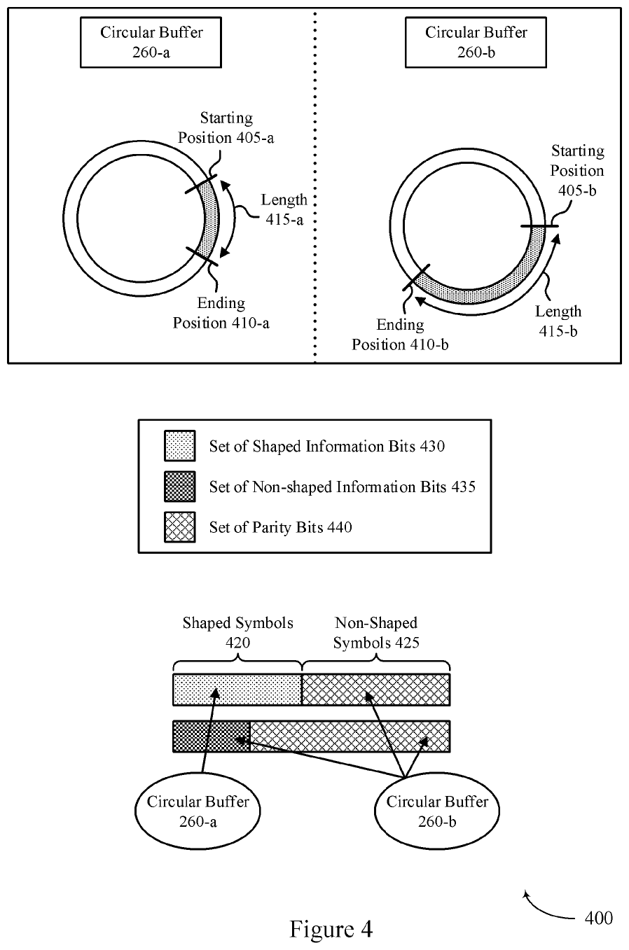

Additionally, or alternatively, the read lengths and starting positions of the two circular buffers 260 (the read operations of the two circular buffers 260) may be associated with a redundancy version associated with an instance of the data message. For example, the device 205 may perform a first read operation of the two circular buffers 260 for the first instance of the data message 220, a second read operation of the two circular buffers 260 for the second instance of the data message 225, a third read operation of the two circular buffers 260 for a third instance of the data message, and so on, where each respective read operation may be associated with a respective (and different) reading or selecting of bits from at least one of the two circular buffers 260. Additional details relating to a first read operation (such as a first buffer reading) associated with the first instance of the data message 220 are illustrated by and described with reference to FIG. 3. Additional details relating to a second read operation (such as a second buffer reading) associated with the second instance of the data message 225 are illustrated by and described with reference to FIG. 4.

FIG. 3 shows an example read operation 300 that supports HARQ designs for PAS. The read operation 300 may implement or be implemented to realize aspects of the wireless communications system 100 or the signaling diagram 200. For example, a device, such as the device 205 as illustrated by and described with reference to FIG. 2, may perform the read operation 300 of the circular buffer 260-a and the circular buffer 260-b to transmit a first instance of a data message, such as the first instance of the data message 220 as illustrated by and described with reference to FIG. 2.

In a first or initial transmission, for example, the device 205 may read a complete set of bits (such as all bits) from the circular buffer 260-a and may read a part (such as a subset or portion) of the circular buffer 260-b. As such, the device 205 may enable sufficient shaping gain (such as to achieve a sufficient or threshold probability for selecting a relatively lower transmission power constellation point). Accordingly, in accordance with the read operation 300, a starting position 305-a and an ending position 310-a of the circular buffer 260-a may be at a same position or at immediately proximate positions such that a read length 315-a of the circular buffer 260-a is an entirety of the circular buffer 260-a. For example, the starting position 305-a of the circular buffer 260-a may be associated with a position S=0 and the ending position 310-a of the circular buffer 260-a may be associated with a position E=n−1, where n is a total quantity of symbols or bits included in the circular buffer 260-a.

Further, in accordance with the read operation 300, a starting position 305-b and an ending position 310-b of the circular buffer 260-b may be defined such that a read length 315-b of the circular buffer 260-b is a subset of the circular buffer 260-b. For example, the starting position 305-b of the circular buffer 260-b may be associated with a position S=0 and the ending position 310-b of the circular buffer 260-b may be associated with a position E=n−1, where n is a total quantity of symbols or bits read from the circular buffer 260-b for the first instance of the data message 220 in accordance with the read operation 300.

For example, the device 205 may read, or generate in accordance with, a set of n symbols 320 from each of the circular buffer 260-a and the circular buffer 260-b for the first instance of the data message. In some implementations, and as illustrated by the read operation 300, the device 205 may read a set of shaped information bits 325 from the circular buffer 260-a and may read a set of non-shaped information bits 330 and a set of parity bits 335 from the circular buffer 260-b. As such, the device 205 may use the set of shaped information bits 325, the set of non-shaped information bits 330, and the set of parity bits 335 for the first instance of the data message.

In some aspects, the circular buffer 260-a may include a set of symbols and the circular buffer 260-b may include a set of bits. As such, the device 205 may use the symbols selected in accordance with the read length 315-a from the circular buffer 260-a (which may be shaped for non-uniform constellation mapping probability) to select, ascertain, or otherwise determine an amplitude of a constellation point for the first instance of the data message 220 and the device 205 may use the bits selected in accordance with the read length 315-b from the circular buffer 260-b (which may be non-shaped for uniform constellation mapping probability) to select, ascertain, or otherwise determine one or more sign bits (such as a plus or minus bits) for the first instance of the data message 220.

FIG. 4 shows an example read operation 400 that supports HARQ designs for PAS. The read operation 400 may implement or be implemented to realize aspects of the wireless communications system 100 or the signaling diagram 200. For example, a device, such as the device 205 as illustrated by and described with reference to FIG. 2, may perform the read operation 400 of the circular buffer 260-a and the circular buffer 260-b to transmit a second instance of a data message, such as the second instance of the data message 225 as illustrated by and described with reference to FIG. 2.

In accordance with the implementations described herein, the device 205 may use or perform a different reading of the circular buffers 260 for the second instance of the data message 225 (such as in a retransmission of the data message). In some implementations, for example, the reading from the circular buffer 260-a and from the circular buffer 260-b may be different for different redundancy versions, may be related to an MCS, or may be related to an assigned block length, or any combination thereof. In other words, the device 205 may support various different read lengths and different starting positions for the two circular buffers 260 and which specific read lengths and starting positions are used for the two circular buffers 260 may be associated with one or both of a redundancy version of the second instance of the data message 225 or a coding rate (such as an MCS) or a block length of the first instance of the data message 220. In some aspects, for example, a symbol length for the first instance of the data message 220 and the second instance of the data message 225 (a retransmission) may be different, but a coding rate of the first instance of the data message 220 and the second instance of the data message 225 may be the same.

Further, whether the device 205 reads from one of the circular buffer 260-a or the circular buffer 260-b or reads from both of the two circular buffers 260 for the second instance of the data message 225 may be associated with a coding rate and a block length of the first instance of the data message 220. For example, if an MCS configures or indicates a coding rate Rᵢₙᵢₜ and a block length N_{B} of the first instance of the data message 220, the device 205 may compare the coding rate Rᵢₙᵢₜ to a first threshold thr₁ (a threshold coding rate) and may compare the block length N_{B} to a second threshold thr₂ (a threshold block length) and may determine whether to read from one or both of the two circular buffers 260 in accordance with the comparison. Table 1, shown below, illustrates an example correspondence between how Rᵢₙᵢₜ (shown in Table 1 generally as R) and N_{B} (shown in table 1 generally as N) compare to thr₁ and thr₂, respectively, and whether the device 205 may read from one or both of the two circular buffers 260 for the second instance of the data message 225.

TABLE 1
Values of (S1, S2) and (L1, L2) for different
Coding Rates R and Block Lengths N

| | | L1 | L2 | S1 | S2 |
|---|---|---|---|---|---|
| R > thr₁ | N < thr₂ | 0 | Nᵣₑ − L1 | NA | K_{0, S2} |
| R < thr₁ | N > thr₂ | Nᵣₑ | Nᵣₑ − L1 | K_{0, S1} | NA |
| R > thr₁ | N > thr₂ | f(r, n) = | Nᵣₑ − L1 | K_{0, S1} | K_{0, S2} |
| | | Nᵣₑ_{_{—}}₁ | | | |
| R < thr₁ | N < thr₂ | f(r, n) = | Nᵣₑ − L1 | K_{0, S1} | K_{0, S2} |
| | | Nᵣₑ_{_{—}}₁ | | | |

As shown in Table 1, L1 may refer to a read length 415-a of the circular buffer 260-a, L2 may refer to a read length 415-b of the circular buffer 260-b, S1 may refer to a starting position 405-a of the circular buffer 260-a, and S2 may refer to a starting position 405-b of the circular buffer 260-b. Further, when using a quantity L1 for reading bits, an actual quantity of readout bits may be equal to L1×(M−1), where M is a one-dimensional quantity of bits that maps to bits excluding one or more sign bits. In other words, M=log₂(OAMsize)/2. In accordance with being a one-dimensional quantity of bits, M may refer to or include bits on an I modulation branch or a Q modulation branch (and might not include bits across both an I branch or a Q branch). Thus, the device 205 may ascertain, calculate, or otherwise determine an ending position 410-a of the circular buffer 260-a in accordance with L1 and S1 and an ending position 410-b of the circular buffer 260-b in accordance with L2 and S2. K_{0,S1} and K_{0,S2} may be values for starting positions of circular buffers with different lengths. As such, L1, L2, S1, and S2 may be designed as a function of coding rate and block length.

In some aspects, Nᵣₑ may refer to a number of allocated resources. For example, for a physical downlink shared channel (PDSCH) or a physical uplink shared channel (PUSCH) transmission, Nye may refer to a number of resource elements that are allocated for the PDSCH or PUSCH transmission. Nᵣₑ may refer to a one-dimensional (referring to or including either an I branch or a Q branch) number of resource elements. As such, for a two-dimensional number of resource elements, the device 205 or the device 210, or both, may use 2Nᵣₑ. Further, values of thr₁ and thr₂ may be preconfigured at the device 205 or may be signaled between the device 205 and the device 210 (in which scenario the device 205 or the device 210 may set values for thr₁ and thr₂ in accordance with a device capability or device-level assistance information). Further, f (r, n) may refer to a function that accounts for or takes as inputs the coding rate and the block length. In some aspects, f r, n)=N_{re_1}, where N_{re_1} may be a preconfigured value (in accordance with a device capability) or calculated by the device 205 in accordance with the coding rate and the block length.

In accordance with the example correspondence illustrated by Table 1, if Rᵢₙᵢₜ>thr₁ and N_{B}<thr₂, (L1, L2)=(0, Nᵣₑ) and (S1, S2)=(NA, K_{0,S2}). In other words, in scenarios associated with a relatively high coding rate and a relatively small block length, the device 205 may read exclusively from the circular buffer 260-b for the second instance of the data message 225. Such an exclusive read from the circular buffer 260-b may effectively reduce a coding rate and effectively increase a block length, which may increase a likelihood of the device 210 successfully decoding the data message. For further example, and as also in accordance with the example correspondence illustrated by Table 1, if Rᵢₙᵢₜ<thr₁ and N_{B}>thr₂, (L1, L2)=(Nᵣₑ, Nᵣₑ−L1), where Nᵣₑ-L1=0 in some scenarios, and (S1, S2)=(K_{0,S1}, NA), which may be equal to (0, 0) in some scenarios. For example, in scenarios associated with a relatively low coding rate and a relatively large block length, the device 205 may read exclusively from the circular buffer 260-a for the second instance of the data message 225. In some implementations, the device 205 may determine that, in such scenarios, a retransmission of the data message may be sufficient with a PAS transmission (using a set of shaped information bits), which may maximize or otherwise increase, favor, or overweight a shaping gain.

Otherwise, (L1, L2)=(Nᵣₑ, Nᵣₑ−L1) and (S1, S2)=(K_{0,S1}, K_{0,S2}). In such scenarios, the device 205 may control or set the starting position 405-a and the read length 415-a of the circular buffer 260-a and the starting position 405-b and the read length 415-b of the circular buffer 260-b in accordance with or to control a tradeoff for shaping and coding via partial shaping and partial HARQ (such as parity bit) transmission. In other words, the device 205 may balance or manage a shaping gain and a HARQ or coding gain in accordance with transmitting the second instance of the data message 225 using a set of shaped bits (a shaping transmission) and a set of non-shaped bits, such as parity bits (a HARQ transmission).

In some implementations, and as illustrated by the read operation 400, the device 205 may transmit the second instance of the data message 225 using a set of shaped symbols 420 and a set of non-shaped symbols 425. In some aspects, the device 205 may read a set of shaped information bits 430 from the circular buffer 260-a to obtain the set of shaped symbols 420 and may read a set of non-shaped information bits 435 and a set of parity bits 440 to obtain the set of non-shaped symbols 425. In some implementations, a value of L1 may be associated with or define a quantity of the set of shaped symbols 420 and a value of L2 may be associated with or define a quantity of the set of non-shaped symbols 425.

Further, (L1, L2) and (S1, S2) may be different for different retransmissions. In other words, the device 205 may support a different version of Table 1 for each potential retransmission of the data message up to an upper limit or maximum number of retransmissions. For example, values for (L1, L2) and (S1, S2) for the second instance of the data message 225 may be different from values for (L1, L2) and (S1, S2) for a third instance of the data message. In some implementations, values for (L1, L2) and (S1, S2) may vary across different retransmissions in accordance with a redundancy version of the different retransmissions. As such, the device 205 may read symbols or bits from one or both of the circular buffer 260-a and the circular buffer 260-b for the second instance of the data message 225 in accordance with one or more of a redundancy version, a coding rate, or a block length.

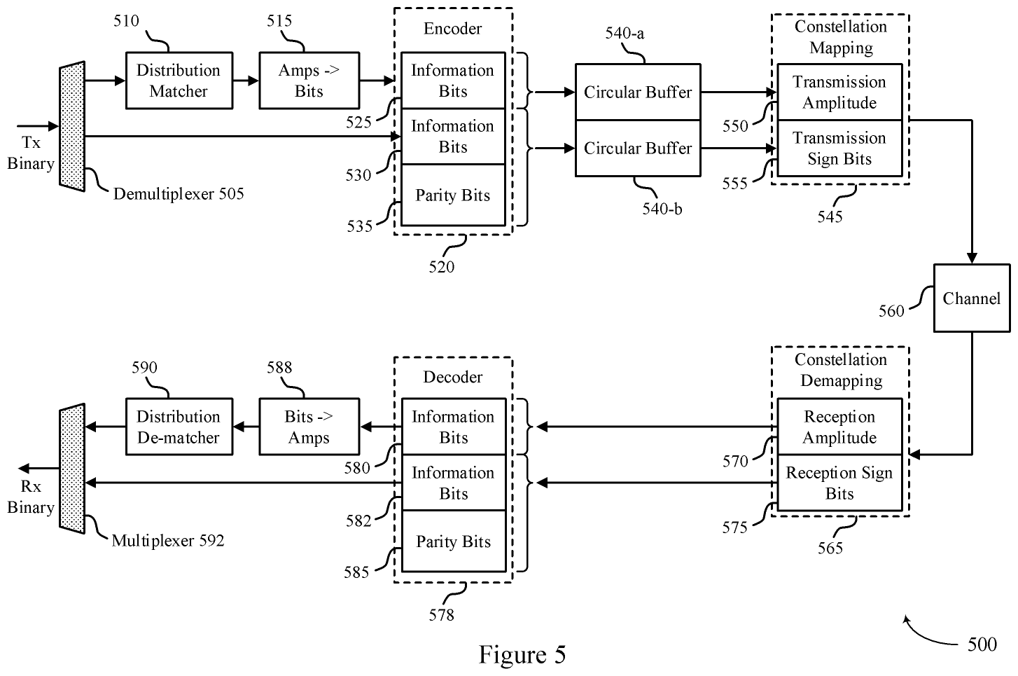

FIG. 5 shows an example PAS communication diagram 500 that supports HARQ designs for PAS. The PAS communication diagram 500 may implement or be implemented to realize aspects of the wireless communications system 100, the signaling diagram 200, the read operation 300, or the read operation 400. For example, a first device and a second device, such as the device 205 and the device 210 as illustrated by and described with reference to FIG. 2, may communicate in accordance with the PAS communication diagram 500 to selectively preserve one or both of shaping gain and feedback gain. In accordance with the implementations described herein, the device 205 may be a transmitting device and perform transmit side operations and the device 210 may be a receiving device and perform receive side operations.

As described in the context of the PAS communication diagram 500, m may be associated with a log-2 of 2^{m} amplitude shift keying (ASK) size (such as a quantity of bits per 1-dimension), k may be a uniform input bit length for a distribution matcher, n may be a shaped output of 1-dimension ASK sequence length, and y may be a rate of an extra (uniform) data bits carried over a set of symbols signs (such as transmission sign bits). Further, a shaping rate of a distribution matcher may be defined as Rₛ=k/n, a forward error correction (FEC) rate may be defined as R_{c}=(m−1+γ)/m≥(m−1)/m, and a transmission rate may be defined as Rₜ=Rₛ+γ<H(A)+γ.

Further, on the transmit side, the device 205 may obtain rate adaptation via tuning rate k/n and non-shaped information bits γn. A distribution matcher may map a binary to a set of positive amplitudes with non-uniform distribution and the non-shaped information and parity bits may map to a sign of a constellation. The uniformly distributed sign bits may not change the constellation distribution. On the receive side, the device 210 may map a de-mapper, or its simplification, for symbol to log-likelihood ratio (LLR) due to the non-uniformly distributed symbols.

For example, the device 205 may input a transmission binary (such as a set of input bits) into a demultiplexer 505 and obtain, as an output, a set of k bits output to a distribution matcher 510 and a set of γn bits output to an encoder 520 (which may be an example of an FEC encoder). The device 205 may input the set of k bits into the distribution matcher 510 to obtain a set of n bits output to an amps-to-bits block 515. The amps-to-bits block 515 may output a set of (m−1)n bits to the encoder 520. The device 205 also may add a set of parity bits 535 to the encoder 520. As such, the device 205 may encode, via the encoder 520, a set of information bits 525 (the (m−1)n bits output from the amps-to-bits block 515) a set of information bits 530 (the set of yn bits output directly from the demultiplexer 505), and the set of parity bits 535. In some aspects, the set of parity bits may include a quantity of (1−γ)n bits.

In some implementations, the device 205 may include the set of information bits 525 (which may be a set of shaped bits or bits that are otherwise associated with a non-uniform probability for constellation mapping) in a circular buffer 540-a and may include the set of information bits 530 and the set of parity bits 535 (each of which may be a set of non-shaped bits or bits that are otherwise associated with a uniform probability for constellation mapping) in the circular buffer 540-b. The circular buffer 540-a and the circular buffer 540-b may be examples of the circular buffer 260-a and the circular buffer 260-b, respectively, as illustrated by and described with reference to FIGS. 2-4. As such, a length of the circular buffer 540-a may be (m−1)n bits or n symbols and a length of the circular buffer 540-b may be (m−1)n/rate bits. In some aspects, m may be a 1-dimensional modulation order and n may be a quantity of symbols (such as a quantity of resource elements in OFDM). In some aspects, the rate (such as the coding rate) may be a preconfigured or predesigned low-density parity-check (LDPC) coding rate (such as ⅓ for base graph 1 (BG1)).

In accordance with a constellation mapping 545, the device 205 may read a set of one or more bits from the circular buffer 540-a (which includes the shaped bits) to select, ascertain, or otherwise determine a transmission amplitude 550 and may read a set of one or more bits from the circular buffer 540-b (which includes the non-shaped bits) to select, ascertain, or otherwise determine a set of transmission sign bits 555. The device 205 may transmit, to the device 210, a selected or generated constellation to convey the set bits associated with the transmit binary. In some aspects, the transmission amplitude 550 may be denoted as A and the transmission sign bits 555 may be denoted as S and the constellation may be understood as a X=A·S. In some aspects, the device 205 may transmit the selected or generated constellation to the device 210 using a channel 560 (which may be denoted as a channel H).

The device 210 may receive the constellation from the device 205 and may input the received constellation into a constellation demapping 565. In accordance with the constellation demapping, the device 210 may obtain a reception amplitude 570 and a set of reception sign bits 575. In some implementations, the device 210 may obtain a set of shaped bits and a set of non-shaped bits and the set of shaped bits may be associated with the transmission amplitude 570 (such as an amplitude of the received data message) and the set of non-shaped bits may be associated with the set of reception sign bits 575 (such as a sign of the received data message).

The device 210 may output the set of shaped bits used to determine the reception amplitude 570 (which may be denoted as A) to a decoder 578 (which may be an example of an FEC decoder) as a set of information bits 580 and may output the set of non-shaped bits used to determine the reception sign bits 575 (which may be denoted as S) to the decoder 578 as a set of information bits 582 and a set of parity bits 585. In aspects in which the device 210 successfully receives the data message from the device 205, the set of information bits 580 may be the same as the set of information bits 525, the set of information bits 582 may be the same as the set of information bits 530, and the set of parity bits 585 may be the same as the set of parity bits 535. Otherwise, if the device 210 incorrectly receives the data message from the device 205, one or more bits at the decoder 578 may be different from a corresponding one or more bits at the encoder 520. In some aspects, the set of information bits 580 may include a quantity of (m−1)n bits, the set of information bits 582 may include a quantity of yn bits, and the set of parity bits 585 may include a quantity of (1−γ)n bits.

The device 210 may input the set of information bits 580 (the (m−1)n bits) into a bits-to-amps block 588 to obtain, as an output of the bits-to-amps block 588, a set of n bits. The device 210 may input the set of n bits into a distribution de-matcher 590 and obtain, as an output of the distribution de-matcher 590, a set of k bits. The device 210 may input the set of k bits and the set of information bits 582 (the set of yn bits) to a multiplexer 592 and obtain, as an output of the multiplexer 592, a reception binary associated with the data message.

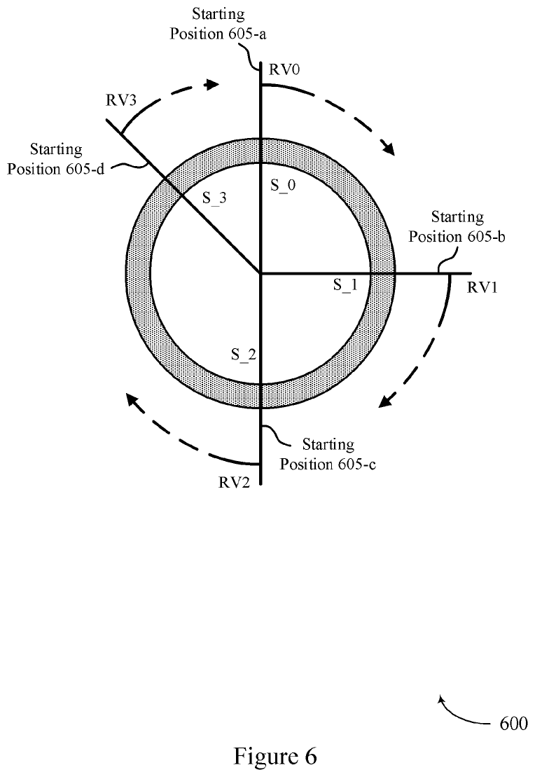

FIG. 6 shows an example buffer 600 that supports HARQ designs for PAS. The buffer 600 may implement or be implemented to realize aspects of the wireless communications system 100, the signaling diagram 200, the read operation 300, the read operation 400, or the PAS communication diagram 500. For example, the buffer 600 may be an example of a circular buffer that a device, such as the device 205 as illustrated by and described with reference to FIG. 2, uses for a HARQ transmission.

For example, the buffer 600 (which may be an example of a circular buffer) may include a set of parity bits and the device 205 may read parity bits from the buffer 600 from different starting positions 605 (where different starting positions 605 may generally refer to one or more of a starting position 605-a, a starting position 605-b, a starting position 605-c, and a starting position 605-d) in accordance with a redundancy version of a given instance or retransmission of a data message. In some implementations, the device 205 may use a starting position 605-a (which may be denoted as S₀) if a redundancy version is equal to 0 (such as for RV0). In some aspects, a redundancy version of 0 may indicate that a given instance of the data message is an initial or first instance of the data message (such as an initial transmission). Additionally, or alternatively, the device 205 may use a starting position 605-b (which may be denoted as S₁) if a redundancy version is equal to 1 (such as for RV1), a starting position 605-c (which may be denoted as S₂) if a redundancy version is equal to 2 (such as for RV2), or a starting position 605-d (which may be denoted as S₃) if a redundancy version is equal to 3 (such as for RV3).

The device 205 may construct the buffer 600 differently for different base graphs. For example, the device 205 may support an LDPC BG1 and an LDPC base graph 2 (BG2) and may support different values of k₀ for the LDPC BG1 and the LDPC BG2. Example constructions of the buffer 600 (such as example values for k₀) for each of the LDPC BG1 and the LDPC BG2 and for different redundancy versions rv_{id} are illustrated by Table 2, shown below. As shown in Table 2, Z_{c} may refer to an example Zadoff-Chu sequence and N_{cb} may refer to a length of the buffer 600 for a given coded block.

TABLE 2
HARQ Buffer Construction for Different Redundancy
Versions rν_{id}

| | k₀ | |
|---|---|---|
| | LDPC Base Graph 1 | LDPC Base Graph 2 |
| rν_{id} | (BG1) | (BG2) |
| 0 | 0 | 0 |
| 1 | $⌊ \frac{17 {N}_{c b}}{66 {Z}_{c}} ⌋ {Z}_{c}$ | $⌊ \frac{13 {N}_{c b}}{50 {Z}_{c}} ⌋ {Z}_{c}$ |
| 2 | $⌊ \frac{33 {N}_{c b}}{66 {Z}_{c}} ⌋ {Z}_{c}$ | $⌊ \frac{25 {N}_{c b}}{50 {Z}_{c}} ⌋ {Z}_{c}$ |
| 3 | $⌊ \frac{56 {N}_{c b}}{66 {Z}_{c}} ⌋ {Z}_{c}$ | $⌊ \frac{43 {N}_{c b}}{50 {Z}_{c}} ⌋ {Z}_{c}$ |

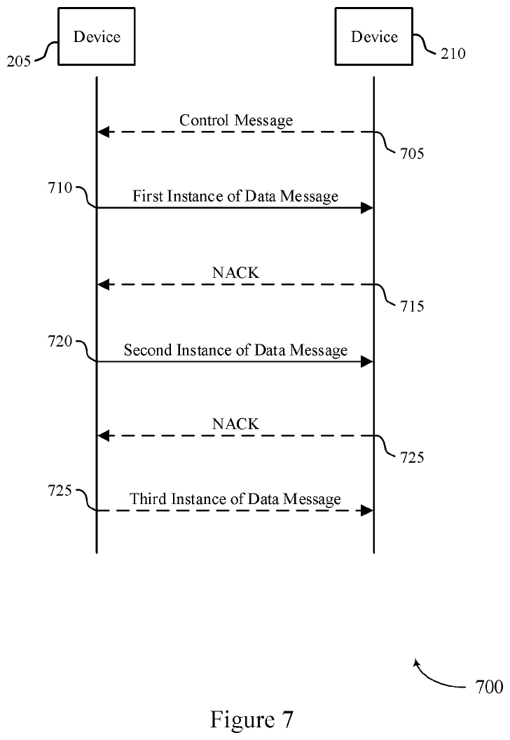

FIG. 7 shows an example process flow 700 that supports HARQ designs for PAS. The process flow 700 may implement or be implemented to realize aspects of the wireless communications system 100, the signaling diagram 200, the read operation 300, the read operation 400, the PAS communication diagram 500, or the buffer 600. For example, the process flow 700 illustrates communication between the device 205 and the device 210. In some implementations, the device 205 and the device 210 may support HARQ designs for PAS such that the device 205 is able to control or manage both a shaping gain (a relatively high probability for a relatively lower transmission power constellation point) and a feedback gain (a level of redundancy of the data message or an incremental redundancy gain) for one or more retransmissions of a data message.

In the following description of the process flow 700, the operations may be performed (such as reported or provided) in a different order than the order shown, or the operations performed by the example devices may be performed in different orders or at different times. For example, specific operations also may be left out of the process flow 700, or other operations may be added to the process flow 700. Further, although some operations or signaling may be shown to occur at different times for discussion purposes, these operations may actually occur at the same time.

At 705, the device 205 may, in some implementations, receive a control message from the device 210. In such implementations, the control message may include scheduling information for a data message, such as for a first or initial instance of the data message. The control message also may include scheduling information for one or more retransmissions of the data message. For example, the control message may include an indication of a coding rate and a block length for a first instance of the data message.

Additionally, or alternatively, the control message may include information associated with a feedback design according to which the device 205 may perform one or more retransmissions of the data message. For example, the control message may include configuration information associated with use of two circular buffers at the device 205 for one or more retransmissions of the data message such that the device 205 may control a shaping gain and a feedback gain, or a tradeoff between the two, in accordance with a coding rate and a block length of the data message or a redundancy version of a given retransmission of the data message, or any combination thereof.

In some implementations, the device 205 may construct a first buffer (such as a first circular buffer) including a first set of information bits associated with the data message and may construct a second buffer (such as a second circular buffer) including a second set of information bits associated with the data message and a set of parity bits. In such implementations, the bits in the first buffer may be associated with a non-uniform probability for constellation mapping and the bits in the second buffer may be associated with uniform probability for constellation mapping.

At 710, the device 205 may transmit, to the device 210, a first instance of the data message. In some implementations, the first instance of the data message may be associated with a first set of shaped bits and a first set of non-shaped bits, where the first set of shaped bits may correspond to a complete set of shaped bits from a first buffer of the device 205 and the first set of non-shaped bits may correspond to a first subset of non-shaped bits from a second buffer of the device 205. The first set of shaped bits may be associated with a first starting position of the first buffer and the first set of non-shaped bits may be associated with a first starting position of the second buffer. In some implementations, in a constellation mapping associated with the first instance of the data message, an amplitude of the first instance of the data message may be associated with the first set of shaped bits and a sign of the first instance of the data message may be associated with the first set of non-shaped bits.

At 715, the device 210 may transmit, to the device 205, an indication of a NACK associated with the first instance of the data message. For example, the device 210 may fail to receive the first instance of the data message and, in some scenarios, may transmit an indication of a NACK for the first instance of the data message to inform the device 205 that the device 210 was unable to successfully receive and decode the first instance of the data message. In some other implementations, the device 205 may expect or assume that the device 210 failed to successfully receive and decode the first instance of the data message in accordance with failing to receive an ACK associated with the first instance of the data message (such as within a threshold amount of time).

At 720, the device 205 may transmit, to the device 210, a second instance of the data message as a retransmission of the data message. In some implementations, the second instance of the data message may be associated with at least one of a second set of shaped bits or a second set of non-shaped bits, where the second set of shaped bits and the second set of non-shaped bits are different from the first set of shaped bits and the first set of non-shaped bits, respectively. For example, the second set of shaped bits may correspond to a subset of the complete set of shaped bits from the first buffer and the second set of non-shaped bits may correspond to a second subset of non-shaped bits from the second buffer that is different from the first subset of non-shaped bits from the second buffer. In some aspects, the second set of shaped bits may be associated with a second starting position of the first buffer and the second set of non-shaped bits may be associated with a second starting position of the second buffer.

In some implementations, the second starting position of the second set of shaped bits, a quantity of the second set of shaped bits (such as a read length of the first buffer), the second starting position of the second set of non-shaped bits, and a quantity of the second set of non-shaped its (such as a read length of the second buffer) may be associated with the coding rate and the block length for the first instance of the data message. In some implementations, the second instance of the data message may be exclusively associated with the second set of shaped bits if the coding rate is less than a threshold coding rate (such as thr₁) and the block length is greater than a threshold block length (such as thr₂). Alternatively, the second instance of the data message may be exclusively associated with the second set of non-shaped bits if the coding rate is greater than the threshold coding rate and the block length is less than the threshold block length. Otherwise, the second instance of the data message may be associated with both the second set of shaped bits and the second set of non-shaped bits. Additionally, or alternatively, the second starting position of the second set of shaped bits, a quantity of the second set of shaped bits (such as a read length of the first buffer), the second starting position of the second set of non-shaped bits, and a quantity of the second set of non-shaped its (such as a read length of the second buffer) may be associated with a redundancy version of the second instance of the data message.

At 725, the device 210 may transmit, to the device 205, an indication of a NACK associated with the second instance of the data message. For example, the device 210 may fail to receive the second instance of the data message and, in some scenarios, may transmit an indication of a NACK for the second instance of the data message to inform the device 205 that the device 210 was unable to successfully receive and decode the second instance of the data message. In some other implementations, the device 205 may expect or assume that the device 210 failed to successfully receive and decode the second instance of the data message in accordance with failing to receive an ACK associated with the second instance of the data message (such as within a threshold amount of time).

At 730, the device 205 may transmit, to the device 210, a third instance of the data message as a second retransmission of the data message. In some implementations, the third instance of the data message may be associated with at least one of a third set of shaped bits or a third set of non-shaped bits, where the third set of shaped bits and the third set of non-shaped bits are different from the second set of shaped bits and the second set of non-shaped bits, respectively.

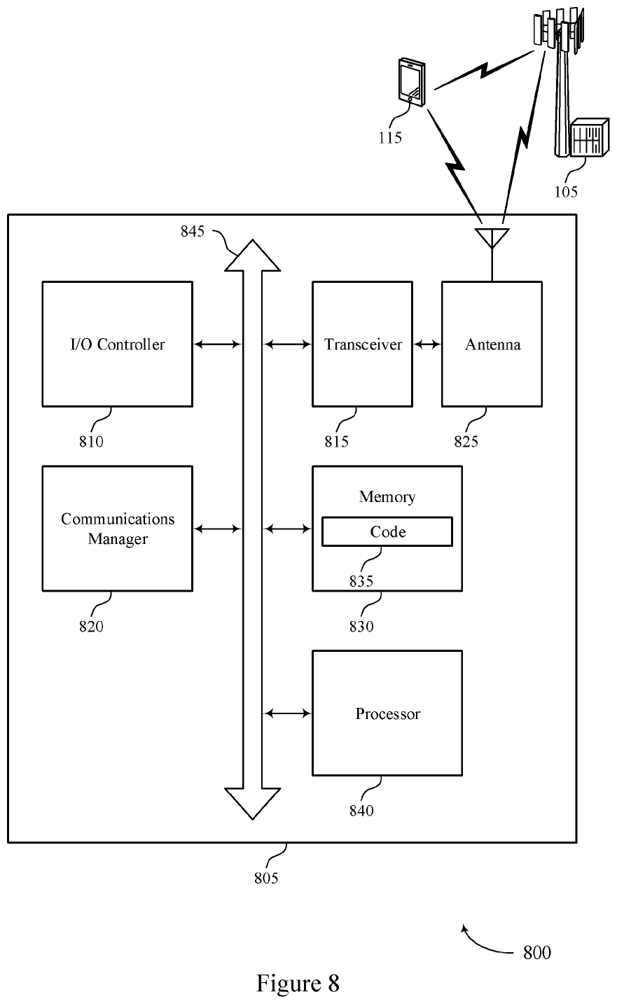

FIG. 8 shows a block diagram 800 of an example device 805 that supports HARQ designs for PAS. The device 805 may communicate (such as wirelessly) with one or more network entities (such as one or more components of one or more BSs 105), one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (such as operatively, communicatively, functionally, electronically, electrically) via one or more buses (such as a bus 845).

The I/O controller 810 may manage input and output signals for the device 805. The I/O controller 810 also may manage peripherals not integrated into the device 805. In some implementations, the I/O controller 810 may represent a physical connection or port to an external peripheral. In some implementations, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some implementations, the I/O controller 810 may be implemented as part of a processor, such as the processor 840. In some implementations, a user may interact with the device 805 via the I/O controller 810 or via hardware components controlled by the I/O controller 810.

In some implementations, the device 805 may include a single antenna 825. However, in some other implementations, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 also may include a modem to modulate the packets, to provide the modulated packets to one or more antennas 825 for transmission, and to demodulate packets received from the one or more antennas 825.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some implementations, the code 835 may not be directly executable by the processor 840 but may cause a computer (such as when compiled and executed) to perform functions described herein. In some implementations, the memory 830 may contain, among other things, a basic I/O system (BIOS) which may control basic hardware or software operation such as the interaction with peripheral components or devices.

The processor 840 may include an intelligent hardware device (such as a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some implementations, the processor 840 may be configured to operate a memory array using a memory controller. In some other implementations, a memory controller may be integrated into the processor 840. The processor 840 may be configured to execute computer-readable instructions stored in a memory (such as the memory 830) to cause the device 805 to perform various functions (such as functions or tasks supporting HARQ designs for PAS). For example, the device 805 or a component of the device 805 may include a processor 840 and memory 830 coupled with or to the processor 840, the processor 840 and memory 830 configured to perform various functions described herein.

The communications manager 820 may support wireless communication in accordance with examples as disclosed herein. For example, the communications manager 820 may be configured as or otherwise support a means for transmitting a first instance of a data message, where the first instance of the data message is associated with a first set of shaped bits and a first set of non-shaped bits. The communications manager 820 may be configured as or otherwise support a means for transmitting a second instance of the data message as a retransmission of the data message, where the second instance of the data message is associated with at least one of a second set of shaped bits or a second set of non-shaped bits, and where the second set of shaped bits and the second set of non-shaped bits are different from the first set of shaped bits and the first set of non-shaped bits, respectively.

In some implementations, the first set of shaped bits of the first instance of the data message corresponds to a complete set of shaped bits from a first buffer and the second set of shaped bits of the second instance of the data message corresponds to a subset of shaped bits of the complete set of shaped bits from the first buffer; and the first set of non-shaped bits of the first instance of the data message corresponds to a first subset of non-shaped bits from a second buffer and the second set of non-shaped bits of the second instance of the data message corresponds to a second subset of non-shaped bits from the second buffer.

In some implementations, the first set of shaped bits is associated with a first starting position of the first buffer and the second set of shaped bits is associated with a second starting position of the first buffer; and the first set of non-shaped bits is associated with a first starting position of the second buffer and the second set of non-shaped bits is associated with a second starting position of the second buffer.

In some implementations, the communications manager 820 may be configured as or otherwise support a means for receiving, via a control message, an indication of a coding rate and a block length for the first instance of the data message, where the second starting position of the second set of shaped bits, a quantity of the second set of shaped bits, the second starting position of the second set of non-shaped bits, and a quantity of the second set of non-shaped bits are associated with the coding rate and the block length for the first instance of the data message.

In some implementations, the second instance of the data message is exclusively associated with the second set of shaped bits if the coding rate is less than a threshold coding rate and the block length is greater than a threshold block length; the second instance of the data message is exclusively associated with the second set of non-shaped bits if the coding rate is greater than the threshold coding rate and the block length is less than the threshold block length; and the second instance of the data message is associated with both the second set of shaped bits and the second set of non-shaped bits otherwise.

In some implementations, the second starting position of the second set of shaped bits, a quantity of the second set of shaped bits, the second starting position of the second set of non-shaped bits, and a quantity of the second set of non-shaped bits are associated with a redundancy version of the second instance of the data message.

In some implementations, the first buffer is a first circular buffer and includes a first set of information bits associated with the data message; and the second buffer is a second circular buffer and includes a second set of information bits associated with the data message and a set of parity bits.

In some implementations, the communications manager 820 may be configured as or otherwise support a means for transmitting a third instance of the data message as a second retransmission of the data message, where the third instance of the data message is associated with at least one of a third set of shaped bits or a third set of non-shaped bits, and where the third set of shaped bits and the third set of non-shaped bits are different from the second set of shaped bits and the second set of non-shaped bits, respectively.

In some implementations, in a constellation mapping associated with the first instance of the data message, an amplitude of the first instance of the data message is associated with the first set of shaped bits and a sign of the first instance of the data message is associated with the first set of non-shaped bits.

In some implementations, the first set of shaped bits and the second set of shaped bits are associated with non-uniform probability; and the first set of non-shaped bits and the second set of non-shaped bits are associated with uniform probability.

Additionally, or alternatively, the communications manager 820 may support wireless communications in accordance with examples as disclosed herein. For example, the communications manager 820 may be configured as or otherwise support a means for receiving a first instance of a data message, where the first instance of the data message is associated with a first set of shaped bits and a first set of non-shaped bits. The communications manager 820 may be configured as or otherwise support a means for receiving a second instance of the data message as a retransmission of the data message, where the second instance of the data message is associated with at least one of a second set of shaped bits or a second set of non-shaped bits, and where the second set of shaped bits and the second set of non-shaped bits are different from the first set of shaped bits and the first set of non-shaped bits, respectively.

In some implementations, the first set of shaped bits of the first instance of the data message is associated with a first starting position and an entirety of a set of multiple shaped bits and the second set of shaped bits of the second instance of the data message is associated with a second starting position and a subset of the set of multiple shaped bits; and the first set of non-shaped bits of the first instance of the data message is associated with a first starting position and a first subset of a set of multiple non-shaped bits and the second set of non-shaped bits of the second instance of the data message is associated with a second starting position and a second subset of the set of multiple non-shaped bits.

In some implementations, the communications manager 820 may be configured as or otherwise support a means for transmitting, via a control message, an indication of a coding rate and a block length for the first instance of the data message, where the second starting position of the second set of shaped bits, a quantity of the second set of shaped bits, the second starting position of the second set of non-shaped bits, and a quantity of the second set of non-shaped bits are associated with the coding rate and the block length for the first instance of the data message.

In some implementations, the second instance of the data message is exclusively associated with the second set of shaped bits if the coding rate is less than a threshold coding rate and the block length is greater than a threshold block length; the second instance of the data message is exclusively associated with the second set of non-shaped bits if the coding rate is greater than the threshold coding rate and the block length is less than the threshold block length; and the second instance of the data message is associated with both the second set of shaped bits and the second set of non-shaped bits otherwise.

In some implementations, the second starting position of the second set of shaped bits, a quantity of the second set of shaped bits, the second starting position of the second set of non-shaped bits, and a quantity of the second set of non-shaped bits are associated with a redundancy version of the second instance of the data message.

In some implementations, the set of multiple shaped bits is associated with a first circular buffer and includes a first set of information bits associated with the data message; and the set of multiple non-shaped bits is associated with a second circular buffer and includes a second set of information bits associated with the data message and a set of parity bits.

In some implementations, the communications manager 820 may be configured as or otherwise support a means for receiving a third instance of the data message as a second retransmission of the data message, where the third instance of the data message is associated with at least one of a third set of shaped bits or a third set of non-shaped bits, and where the third set of shaped bits and the third set of non-shaped bits are different from the second set of shaped bits and the second set of non-shaped bits, respectively.

In some implementations, in a constellation demapping associated with the first instance of the data message, an amplitude of the first instance of the data message is associated with the first set of shaped bits and a sign of the first instance of the data message is associated with the first set of non-shaped bits.

In some implementations, the first set of shaped bits and the second set of shaped bits are associated with non-uniform probability; and the first set of non-shaped bits and the second set of non-shaped bits are associated with uniform probability.

In some implementations, the communications manager 820 may be configured to perform various operations (such as receiving, monitoring, transmitting) using or otherwise in cooperation with the transceiver 815, the one or more antennas 825, or any combination thereof. Although the communications manager 820 is illustrated as a separate component, in some implementations, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of HARQ designs for PAS as described herein, or the processor 840 and the memory 830 may be otherwise configured to perform or support such operations.

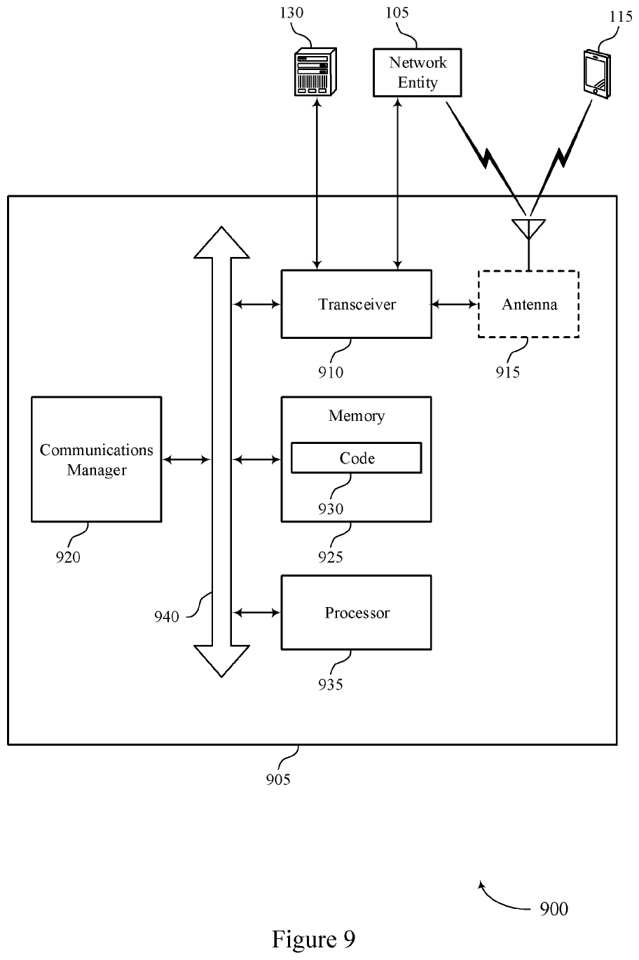

FIG. 9 shows a block diagram 900 of an example device 905 that supports HARQ designs for PAS. The device 905 may communicate with one or more network entities (such as one or more components of one or more BSs 105), one or more UEs 115, or any combination thereof, which may include communications over one or more wired interfaces, over one or more wireless interfaces, or any combination thereof. The device 905 may include components that support outputting and obtaining communications, such as a communications manager 920, a transceiver 910, an antenna 915, a memory 925, code 930, and a processor 935. These components may be in electronic communication or otherwise coupled (such as operatively, communicatively, functionally, electronically, electrically) via one or more buses (such as a bus 940).

The transceiver 910 may support bi-directional communications via wired links, wireless links, or both as described herein. In some implementations, the transceiver 910 may include a wired transceiver and may communicate bi-directionally with another wired transceiver. Additionally, or alternatively, in some implementations, the transceiver 910 may include a wireless transceiver and may communicate bi-directionally with another wireless transceiver. In some implementations, the device 905 may include one or more antennas 915, which may be capable of transmitting or receiving wireless transmissions (such as concurrently). The transceiver 910 also may include a modem to modulate signals, to provide the modulated signals for transmission (such as by one or more antennas 915, by a wired transmitter), to receive modulated signals (such as from one or more antennas 915, from a wired receiver), and to demodulate signals. In some implementations, the transceiver may be operable to support communications via one or more communications links (such as a communication link 125, a backhaul communication link 120, a midhaul communication link 162, a fronthaul communication link 168).

The memory 925 may include RAM and ROM. The memory 925 may store computer-readable, computer-executable code 930 including instructions that, when executed by the processor 935, cause the device 905 to perform various functions described herein. The code 930 may be stored in a non-transitory computer-readable medium such as system memory or another type of memory. In some implementations, the code 930 may not be directly executable by the processor 935 but may cause a computer (such as when compiled and executed) to perform functions described herein. In some implementations, the memory 925 may contain, among other things, a BIOS which may control basic hardware or software operation such as the interaction with peripheral components or devices.

The processor 935 may include an intelligent hardware device (such as a general-purpose processor, a DSP, an ASIC, a CPU, an FPGA, a microcontroller, a programmable logic device, discrete gate or transistor logic, a discrete hardware component, or any combination thereof). In some implementations, the processor 935 may be configured to operate a memory array using a memory controller. In some other implementations, a memory controller may be integrated into the processor 935. The processor 935 may be configured to execute computer-readable instructions stored in a memory (such as the memory 925) to cause the device 905 to perform various functions (such as functions or tasks supporting HARQ designs for PAS). For example, the device 905 or a component of the device 905 may include a processor 935 and memory 925 coupled with the processor 935, the processor 935 and memory 925 configured to perform various functions described herein. The processor 935 may be an example of a cloud-computing platform (such as one or more physical nodes and supporting software such as operating systems, virtual machines, or container instances) that may host the functions (such as by executing code 930) to perform the functions of the device 905.

In some implementations, a bus 940 may support communications of (such as within) a protocol layer of a protocol stack. In some implementations, a bus 940 may support communications associated with a logical channel of a protocol stack (such as between protocol layers of a protocol stack), which may include communications performed within a component of the device 905, or between different components of the device 905 that may be co-located or located in different locations (such as where the device 905 may refer to a system in which one or more of the communications manager 920, the transceiver 910, the memory 925, the code 930, and the processor 935 may be located in one of the different components or divided between different components).

In some implementations, the communications manager 920 may manage aspects of communications with a core network 130 (such as via one or more wired or wireless backhaul links). For example, the communications manager 920 may manage the transfer of data communications for client devices, such as one or more UEs 115. In some implementations, the communications manager 920 may manage communications with other network entities 105, and may include a controller or scheduler for controlling communications with UEs 115 in cooperation with other network entities 105. In some implementations, the communications manager 920 may support an X2 interface within an LTE/LTE-A wireless communications network technology to provide communication between network entities 105.

The communications manager 920 may support wireless communication in accordance with examples as disclosed herein. For example, the communications manager 920 may be configured as or otherwise support a means for transmitting a first instance of a data message, where the first instance of the data message is associated with a first set of shaped bits and a first set of non-shaped bits. The communications manager 920 may be configured as or otherwise support a means for transmitting a second instance of the data message as a retransmission of the data message, where the second instance of the data message is associated with at least one of a second set of shaped bits or a second set of non-shaped bits, and where the second set of shaped bits and the second set of non-shaped bits are different from the first set of shaped bits and the first set of non-shaped bits, respectively.

In some implementations, the first set of shaped bits of the first instance of the data message corresponds to a complete set of shaped bits from a first buffer and the second set of shaped bits of the second instance of the data message corresponds to a subset of shaped bits of the complete set of shaped bits from the first buffer; and the first set of non-shaped bits of the first instance of the data message corresponds to a first subset of non-shaped bits from a second buffer and the second set of non-shaped bits of the second instance of the data message corresponds to a second subset of non-shaped bits from the second buffer.

In some implementations, the first set of shaped bits is associated with a first starting position of the first buffer and the second set of shaped bits is associated with a second starting position of the first buffer; and the first set of non-shaped bits is associated with a first starting position of the second buffer and the second set of non-shaped bits is associated with a second starting position of the second buffer.

In some implementations, the communications manager 920 may be configured as or otherwise support a means for receiving, via a control message, an indication of a coding rate and a block length for the first instance of the data message, where the second starting position of the second set of shaped bits, a quantity of the second set of shaped bits, the second starting position of the second set of non-shaped bits, and a quantity of the second set of non-shaped bits are associated with the coding rate and the block length for the first instance of the data message.

In some implementations, the second instance of the data message is exclusively associated with the second set of shaped bits if the coding rate is less than a threshold coding rate and the block length is greater than a threshold block length; the second instance of the data message is exclusively associated with the second set of non-shaped bits if the coding rate is greater than the threshold coding rate and the block length is less than the threshold block length; and the second instance of the data message is associated with both the second set of shaped bits and the second set of non-shaped bits otherwise.

In some implementations, the second starting position of the second set of shaped bits, a quantity of the second set of shaped bits, the second starting position of the second set of non-shaped bits, and a quantity of the second set of non-shaped bits are associated with a redundancy version of the second instance of the data message.

In some implementations, the first buffer is a first circular buffer and includes a first set of information bits associated with the data message; and the second buffer is a second circular buffer and includes a second set of information bits associated with the data message and a set of parity bits.

In some implementations, the communications manager 920 may be configured as or otherwise support a means for transmitting a third instance of the data message as a second retransmission of the data message, where the third instance of the data message is associated with at least one of a third set of shaped bits or a third set of non-shaped bits, and where the third set of shaped bits and the third set of non-shaped bits are different from the second set of shaped bits and the second set of non-shaped bits, respectively.

In some implementations, in a constellation mapping associated with the first instance of the data message, an amplitude of the first instance of the data message is associated with the first set of shaped bits and a sign of the first instance of the data message is associated with the first set of non-shaped bits.

In some implementations, the first set of shaped bits and the second set of shaped bits are associated with non-uniform probability; and the first set of non-shaped bits and the second set of non-shaped bits are associated with uniform probability.

Additionally, or alternatively, the communications manager 920 may support wireless communications in accordance with examples as disclosed herein. For example, the communications manager 920 may be configured as or otherwise support a means for receiving a first instance of a data message, where the first instance of the data message is associated with a first set of shaped bits and a first set of non-shaped bits. The communications manager 920 may be configured as or otherwise support a means for receiving a second instance of the data message as a retransmission of the data message, where the second instance of the data message is associated with at least one of a second set of shaped bits or a second set of non-shaped bits, and where the second set of shaped bits and the second set of non-shaped bits are different from the first set of shaped bits and the first set of non-shaped bits, respectively.

In some implementations, the first set of shaped bits of the first instance of the data message is associated with a first starting position and an entirety of a set of multiple shaped bits and the second set of shaped bits of the second instance of the data message is associated with a second starting position and a subset of the set of multiple shaped bits; and the first set of non-shaped bits of the first instance of the data message is associated with a first starting position and a first subset of a set of multiple non-shaped bits and the second set of non-shaped bits of the second instance of the data message is associated with a second starting position and a second subset of the set of multiple non-shaped bits.

In some implementations, the communications manager 920 may be configured as or otherwise support a means for transmitting, via a control message, an indication of a coding rate and a block length for the first instance of the data message, where the second starting position of the second set of shaped bits, a quantity of the second set of shaped bits, the second starting position of the second set of non-shaped bits, and a quantity of the second set of non-shaped bits are associated with the coding rate and the block length for the first instance of the data message.

In some implementations, the second instance of the data message is exclusively associated with the second set of shaped bits if the coding rate is less than a threshold coding rate and the block length is greater than a threshold block length; the second instance of the data message is exclusively associated with the second set of non-shaped bits if the coding rate is greater than the threshold coding rate and the block length is less than the threshold block length; and the second instance of the data message is associated with both the second set of shaped bits and the second set of non-shaped bits otherwise.

In some implementations, the second starting position of the second set of shaped bits, a quantity of the second set of shaped bits, the second starting position of the second set of non-shaped bits, and a quantity of the second set of non-shaped bits are associated with a redundancy version of the second instance of the data message.

In some implementations, the set of multiple shaped bits is associated with a first circular buffer and includes a first set of information bits associated with the data message; and the set of multiple non-shaped bits is associated with a second circular buffer and includes a second set of information bits associated with the data message and a set of parity bits.

In some implementations, the communications manager 920 may be configured as or otherwise support a means for receiving a third instance of the data message as a second retransmission of the data message, where the third instance of the data message is associated with at least one of a third set of shaped bits or a third set of non-shaped bits, and where the third set of shaped bits and the third set of non-shaped bits are different from the second set of shaped bits and the second set of non-shaped bits, respectively.

In some implementations, in a constellation demapping associated with the first instance of the data message, an amplitude of the first instance of the data message is associated with the first set of shaped bits and a sign of the first instance of the data message is associated with the first set of non-shaped bits.

In some implementations, the first set of shaped bits and the second set of shaped bits are associated with non-uniform probability; and the first set of non-shaped bits and the second set of non-shaped bits are associated with uniform probability.

In some implementations, the communications manager 920 may be configured to perform various operations (such as receiving, obtaining, monitoring, outputting, transmitting) using or otherwise in cooperation with the transceiver 910, the one or more antennas 915 (such as where applicable), or any combination thereof. Although the communications manager 920 is illustrated as a separate component, in some implementations, one or more functions described with reference to the communications manager 920 may be supported by or performed by the processor 935, the memory 925, the code 930, the transceiver 910, or any combination thereof. For example, the code 930 may include instructions executable by the processor 935 to cause the device 905 to perform various aspects of HARQ designs for PAS as described herein, or the processor 935 and the memory 925 may be otherwise configured to perform or support such operations.

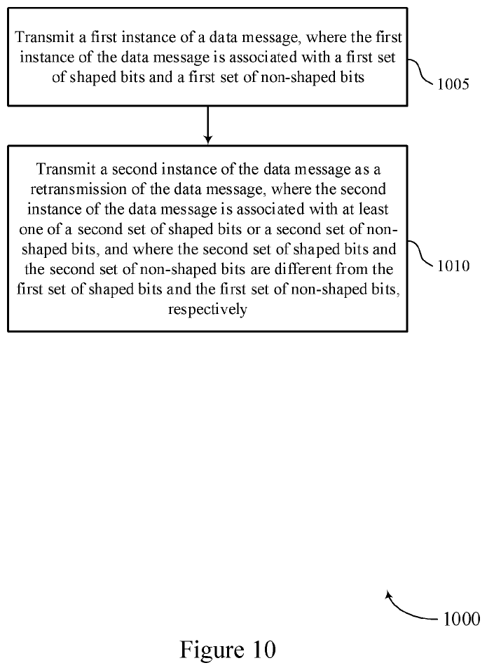

FIG. 10 shows a flowchart illustrating an example method 1000 that supports HARQ designs for PAS. The operations of the method 1000 may be implemented by a UE or a network entity or its components as described herein. For example, the operations of the method 1000 may be performed by a UE 115 or a network entity as described with reference to FIGS. 1-9. In some implementations, a UE or a network entity may execute a set of instructions to control the functional elements of the UE or the network entity to perform the described functions. Additionally, or alternatively, the UE or the network entity may perform aspects of the described functions using special-purpose hardware.

At 1005, the method may include transmitting a first instance of a data message, where the first instance of the data message is associated with a first set of shaped bits and a first set of non-shaped bits. The operations of 1005 may be performed in accordance with examples as disclosed herein. In some implementations, aspects of the operations of 1005 may be performed by a communications manager 820 or a communications manager 920 as described with reference to FIG. 8 or 9, respectively.

At 1010, the method may include transmitting a second instance of the data message as a retransmission of the data message, where the second instance of the data message is associated with at least one of a second set of shaped bits or a second set of non-shaped bits, and where the second set of shaped bits and the second set of non-shaped bits are different from the first set of shaped bits and the first set of non-shaped bits, respectively. The operations of 1010 may be performed in accordance with examples as disclosed herein. In some implementations, aspects of the operations of 1010 may be performed by a communications manager 820 or a communications manager 920 as described with reference to FIG. 8 or 9, respectively.

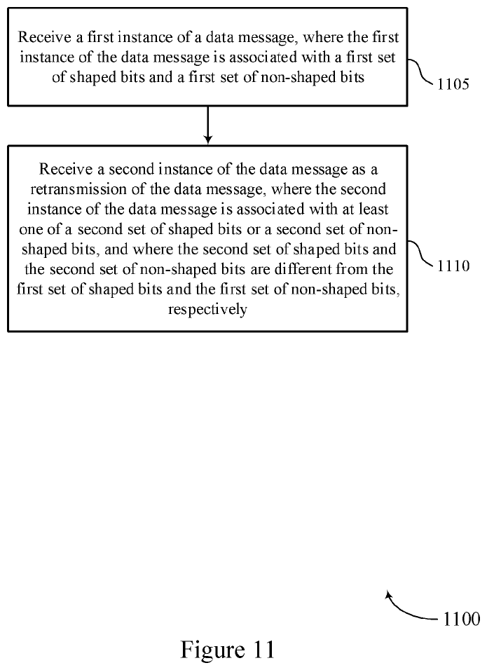

FIG. 11 shows a flowchart illustrating an example method 1100 that supports HARQ designs for PAS. The operations of the method 1100 may be implemented by a UE or a network entity or its components as described herein. For example, the operations of the method 1100 may be performed by a UE 115 or a network entity as described with reference to FIGS. 1-9. In some implementations, a UE or a network entity may execute a set of instructions to control the functional elements of the UE or the network entity to perform the described functions. Additionally, or alternatively, the UE or the network entity may perform aspects of the described functions using special-purpose hardware.

At 1105, the method may include receiving a first instance of a data message, where the first instance of the data message is associated with a first set of shaped bits and a first set of non-shaped bits. The operations of 1105 may be performed in accordance with examples as disclosed herein. In some implementations, aspects of the operations of 1105 may be performed by a communications manager 820 or a communications manager 920 as described with reference to FIG. 8 or 9, respectively.

At 1110, the method may include receiving a second instance of the data message as a retransmission of the data message, where the second instance of the data message is associated with at least one of a second set of shaped bits or a second set of non-shaped bits, and where the second set of shaped bits and the second set of non-shaped bits are different from the first set of shaped bits and the first set of non-shaped bits, respectively. The operations of 1110 may be performed in accordance with examples as disclosed herein. In some implementations, aspects of the operations of 1110 may be performed by a communications manager 820 or a communications manager 920 as described with reference to FIG. 8 or 9, respectively.

The following provides an overview of some aspects of the present disclosure:
Aspect 1: An apparatus for wireless communication, including: an interface configured to: output a first instance of a data message, where the first instance of the data message is associated with a first set of shaped bits and a first set of non-shaped bits; and output a second instance of the data message as a retransmission of the data message, where the second instance of the data message is associated with at least one of a second set of shaped bits or a second set of non-shaped bits, and where the second set of shaped bits and the second set of non-shaped bits are different from the first set of shaped bits and the first set of non-shaped bits, respectively.
Aspect 2: The apparatus of aspect 1, where: the first set of shaped bits of the first instance of the data message corresponds to a complete set of shaped bits from a first buffer and the second set of shaped bits of the second instance of the data message corresponds to a subset of shaped bits of the complete set of shaped bits from the first buffer; and the first set of non-shaped bits of the first instance of the data message corresponds to a first subset of non-shaped bits from a second buffer and the second set of non-shaped bits of the second instance of the data message corresponds to a second subset of non-shaped bits from the second buffer.
Aspect 3: The apparatus of aspect 2, where: the first set of shaped bits is associated with a first starting position of the first buffer and the second set of shaped bits is associated with a second starting position of the first buffer; and the first set of non-shaped bits is associated with a first starting position of the second buffer and the second set of non-shaped bits is associated with a second starting position of the second buffer.
Aspect 4: The apparatus of aspect 3, where the interface is further configured to: obtain, via a control message, an indication of a coding rate and a block length for the first instance of the data message, where the second starting position of the second set of shaped bits, a quantity of the second set of shaped bits, the second starting position of the second set of non-shaped bits, and a quantity of the second set of non-shaped bits are associated with the coding rate and the block length for the first instance of the data message.
Aspect 5: The apparatus of aspect 4, where: the second instance of the data message is exclusively associated with the second set of shaped bits if the coding rate is less than a threshold coding rate and the block length is greater than a threshold block length; the second instance of the data message is exclusively associated with the second set of non-shaped bits if the coding rate is greater than the threshold coding rate and the block length is less than the threshold block length; and the second instance of the data message is associated with both the second set of shaped bits and the second set of non-shaped bits otherwise.
Aspect 6: The apparatus of any of aspects 3-5, where the second starting position of the second set of shaped bits, a quantity of the second set of shaped bits, the second starting position of the second set of non-shaped bits, and a quantity of the second set of non-shaped bits are associated with a redundancy version of the second instance of the data message.
Aspect 7: The apparatus of any of aspects 2-6, where: the first buffer is a first circular buffer and includes a first set of information bits associated with the data message; and the second buffer is a second circular buffer and includes a second set of information bits associated with the data message and a set of parity bits.
Aspect 8: The apparatus of any of aspects 1-7, where the interface is further configured to: output a third instance of the data message as a second retransmission of the data message, where the third instance of the data message is associated with at least one of a third set of shaped bits or a third set of non-shaped bits, and where the third set of shaped bits and the third set of non-shaped bits are different from the second set of shaped bits and the second set of non-shaped bits, respectively.
Aspect 9: The apparatus of any of aspects 1-8, where in a constellation mapping associated with the first instance of the data message, an amplitude of the first instance of the data message is associated with the first set of shaped bits and a sign of the first instance of the data message is associated with the first set of non-shaped bits.
Aspect 10: The apparatus of any of aspects 1-9, where: the first set of shaped bits and the second set of shaped bits are associated with non-uniform probability; and the first set of non-shaped bits and the second set of non-shaped bits are associated with uniform probability.
Aspect 11: An apparatus for wireless communications, including: an interface configured to: obtain a first instance of a data message, where the first instance of the data message is associated with a first set of shaped bits and a first set of non-shaped bits; and obtain a second instance of the data message as a retransmission of the data message, where the second instance of the data message is associated with at least one of a second set of shaped bits or a second set of non-shaped bits, and where the second set of shaped bits and the second set of non-shaped bits are different from the first set of shaped bits and the first set of non-shaped bits, respectively.
Aspect 12: The apparatus of aspect 11, where: the first set of shaped bits of the first instance of the data message is associated with a first starting position and an entirety of a set of multiple shaped bits and the second set of shaped bits of the second instance of the data message is associated with a second starting position and a subset of the set of multiple shaped bits; and the first set of non-shaped bits of the first instance of the data message is associated with a first starting position and a first subset of a set of multiple non-shaped bits and the second set of non-shaped bits of the second instance of the data message is associated with a second starting position and a second subset of the set of multiple non-shaped bits.
Aspect 13: The apparatus of aspect 12, where the interface is further configured to: output, via a control message, an indication of a coding rate and a block length for the first instance of the data message, where the second starting position of the second set of shaped bits, a quantity of the second set of shaped bits, the second starting position of the second set of non-shaped bits, and a quantity of the second set of non-shaped bits are associated with the coding rate and the block length for the first instance of the data message.
Aspect 14: The apparatus of aspect 13, where: the second instance of the data message is exclusively associated with the second set of shaped bits if the coding rate is less than a threshold coding rate and the block length is greater than a threshold block length; the second instance of the data message is exclusively associated with the second set of non-shaped bits if the coding rate is greater than the threshold coding rate and the block length is less than the threshold block length; and the second instance of the data message is associated with both the second set of shaped bits and the second set of non-shaped bits otherwise.
Aspect 15: The apparatus of any of aspects 12-14, where the second starting position of the second set of shaped bits, a quantity of the second set of shaped bits, the second starting position of the second set of non-shaped bits, and a quantity of the second set of non-shaped bits are associated with a redundancy version of the second instance of the data message.
Aspect 16: The apparatus of any of aspects 12-15, where: the set of multiple shaped bits is associated with a first circular buffer and includes a first set of information bits associated with the data message; and the set of multiple non-shaped bits is associated with a second circular buffer and includes a second set of information bits associated with the data message and a set of parity bits.
Aspect 17: The apparatus of any of aspects 11-16, where the interface is further configured to: obtain a third instance of the data message as a second retransmission of the data message, where the third instance of the data message is associated with at least one of a third set of shaped bits or a third set of non-shaped bits, and where the third set of shaped bits and the third set of non-shaped bits are different from the second set of shaped bits and the second set of non-shaped bits, respectively.
Aspect 18: The apparatus of any of aspects 11-17, where in a constellation demapping associated with the first instance of the data message, an amplitude of the first instance of the data message is associated with the first set of shaped bits and a sign of the first instance of the data message is associated with the first set of non-shaped bits.
Aspect 19: The apparatus of any of aspects 11-18, where: the first set of shaped bits and the second set of shaped bits are associated with non-uniform probability; and the first set of non-shaped bits and the second set of non-shaped bits are associated with uniform probability.
Aspect 20: A method for wireless communication, including: transmitting a first instance of a data message, where the first instance of the data message is associated with a first set of shaped bits and a first set of non-shaped bits; and transmitting a second instance of the data message as a retransmission of the data message, where the second instance of the data message is associated with at least one of a second set of shaped bits or a second set of non-shaped bits, and where the second set of shaped bits and the second set of non-shaped bits are different from the first set of shaped bits and the first set of non-shaped bits, respectively.
Aspect 21: The method of aspect 20, where the first set of shaped bits of the first instance of the data message corresponds to a complete set of shaped bits from a first buffer and the second set of shaped bits of the second instance of the data message corresponds to a subset of shaped bits of the complete set of shaped bits from the first buffer; and the first set of non-shaped bits of the first instance of the data message corresponds to a first subset of non-shaped bits from a second buffer and the second set of non-shaped bits of the second instance of the data message corresponds to a second subset of non-shaped bits from the second buffer.
Aspect 22: The method of aspect 21, where the first set of shaped bits is associated with a first starting position of the first buffer and the second set of shaped bits is associated with a second starting position of the first buffer; and the first set of non-shaped bits is associated with a first starting position of the second buffer and the second set of non-shaped bits is associated with a second starting position of the second buffer.
Aspect 23: The method of aspect 22, further including: receiving, via a control message, an indication of a coding rate and a block length for the first instance of the data message, where the second starting position of the second set of shaped bits, a quantity of the second set of shaped bits, the second starting position of the second set of non-shaped bits, and a quantity of the second set of non-shaped bits are associated with the coding rate and the block length for the first instance of the data message.
Aspect 24: The method of aspect 23, where the second instance of the data message is exclusively associated with the second set of shaped bits if the coding rate is less than a threshold coding rate and the block length is greater than a threshold block length; the second instance of the data message is exclusively associated with the second set of non-shaped bits if the coding rate is greater than the threshold coding rate and the block length is less than the threshold block length; and the second instance of the data message is associated with both the second set of shaped bits and the second set of non-shaped bits otherwise.
Aspect 25: The method of any of aspects 22-24, where the second starting position of the second set of shaped bits, a quantity of the second set of shaped bits, the second starting position of the second set of non-shaped bits, and a quantity of the second set of non-shaped bits are associated with a redundancy version of the second instance of the data message.
Aspect 26: The method of any of aspects 21-25, where the first buffer is a first circular buffer and includes a first set of information bits associated with the data message; and the second buffer is a second circular buffer and includes a second set of information bits associated with the data message and a set of parity bits.
Aspect 27: The method of any of aspects 20-26, further including: transmitting a third instance of the data message as a second retransmission of the data message, where the third instance of the data message is associated with at least one of a third set of shaped bits or a third set of non-shaped bits, and where the third set of shaped bits and the third set of non-shaped bits are different from the second set of shaped bits and the second set of non-shaped bits, respectively.
Aspect 28: The method of any of aspects 20-27, where in a constellation mapping associated with the first instance of the data message, an amplitude of the first instance of the data message is associated with the first set of shaped bits and a sign of the first instance of the data message is associated with the first set of non-shaped bits.
Aspect 29: The method of any of aspects 20-28, where the first set of shaped bits and the second set of shaped bits are associated with non-uniform probability; and the first set of non-shaped bits and the second set of non-shaped bits are associated with uniform probability.
Aspect 30: A method for wireless communications, including: receiving a first instance of a data message, where the first instance of the data message is associated with a first set of shaped bits and a first set of non-shaped bits; and receiving a second instance of the data message as a retransmission of the data message, where the second instance of the data message is associated with at least one of a second set of shaped bits or a second set of non-shaped bits, and where the second set of shaped bits and the second set of non-shaped bits are different from the first set of shaped bits and the first set of non-shaped bits, respectively.
Aspect 31: The method of aspect 30, where the first set of shaped bits of the first instance of the data message is associated with a first starting position and an entirety of a set of multiple shaped bits and the second set of shaped bits of the second instance of the data message is associated with a second starting position and a subset of the set of multiple shaped bits; and the first set of non-shaped bits of the first instance of the data message is associated with a first starting position and a first subset of a set of multiple non-shaped bits and the second set of non-shaped bits of the second instance of the data message is associated with a second starting position and a second subset of the set of multiple non-shaped bits.
Aspect 32: The method of aspect 31, further including: transmitting, via a control message, an indication of a coding rate and a block length for the first instance of the data message, where the second starting position of the second set of shaped bits, a quantity of the second set of shaped bits, the second starting position of the second set of non-shaped bits, and a quantity of the second set of non-shaped bits are associated with the coding rate and the block length for the first instance of the data message.
Aspect 33: The method of aspect 32, where the second instance of the data message is exclusively associated with the second set of shaped bits if the coding rate is less than a threshold coding rate and the block length is greater than a threshold block length; the second instance of the data message is exclusively associated with the second set of non-shaped bits if the coding rate is greater than the threshold coding rate and the block length is less than the threshold block length; and the second instance of the data message is associated with both the second set of shaped bits and the second set of non-shaped bits otherwise.
Aspect 34: The method of any of aspects 31-33, where the second starting position of the second set of shaped bits, a quantity of the second set of shaped bits, the second starting position of the second set of non-shaped bits, and a quantity of the second set of non-shaped bits are associated with a redundancy version of the second instance of the data message.
Aspect 35: The method of any of aspects 31-34, where the set of multiple shaped bits is associated with a first circular buffer and includes a first set of information bits associated with the data message; and the set of multiple non-shaped bits is associated with a second circular buffer and includes a second set of information bits associated with the data message and a set of parity bits.
Aspect 36: The method of any of aspects 30-35, further including: receiving a third instance of the data message as a second retransmission of the data message, where the third instance of the data message is associated with at least one of a third set of shaped bits or a third set of non-shaped bits, and where the third set of shaped bits and the third set of non-shaped bits are different from the second set of shaped bits and the second set of non-shaped bits, respectively.
Aspect 37: The method of any of aspects 30-36, where in a constellation demapping associated with the first instance of the data message, an amplitude of the first instance of the data message is associated with the first set of shaped bits and a sign of the first instance of the data message is associated with the first set of non-shaped bits.
Aspect 38: The method of any of aspects 30-37, where the first set of shaped bits and the second set of shaped bits are associated with non-uniform probability; and the first set of non-shaped bits and the second set of non-shaped bits are associated with uniform probability.
Aspect 39: An apparatus for wireless communication, including: means for transmitting a first instance of a data message, where the first instance of the data message is associated with a first set of shaped bits and a first set of non-shaped bits; and means for transmitting a second instance of the data message as a retransmission of the data message, where the second instance of the data message is associated with at least one of a second set of shaped bits or a second set of non-shaped bits, and where the second set of shaped bits and the second set of non-shaped bits are different from the first set of shaped bits and the first set of non-shaped bits, respectively.
Aspect 40: The apparatus of aspect 39, where the first set of shaped bits of the first instance of the data message corresponds to a complete set of shaped bits from a first buffer and the second set of shaped bits of the second instance of the data message corresponds to a subset of shaped bits of the complete set of shaped bits from the first buffer; and the first set of non-shaped bits of the first instance of the data message corresponds to a first subset of non-shaped bits from a second buffer and the second set of non-shaped bits of the second instance of the data message corresponds to a second subset of non-shaped bits from the second buffer.
Aspect 41: The apparatus of aspect 40, where the first set of shaped bits is associated with a first starting position of the first buffer and the second set of shaped bits is associated with a second starting position of the first buffer; and the first set of non-shaped bits is associated with a first starting position of the second buffer and the second set of non-shaped bits is associated with a second starting position of the second buffer.
Aspect 42: The apparatus of aspect 41, further including: means for receiving, via a control message, an indication of a coding rate and a block length for the first instance of the data message, where the second starting position of the second set of shaped bits, a quantity of the second set of shaped bits, the second starting position of the second set of non-shaped bits, and a quantity of the second set of non-shaped bits are associated with the coding rate and the block length for the first instance of the data message.
Aspect 43: The apparatus of aspect 42, where the second instance of the data message is exclusively associated with the second set of shaped bits if the coding rate is less than a threshold coding rate and the block length is greater than a threshold block length; the second instance of the data message is exclusively associated with the second set of non-shaped bits if the coding rate is greater than the threshold coding rate and the block length is less than the threshold block length; and the second instance of the data message is associated with both the second set of shaped bits and the second set of non-shaped bits otherwise.
Aspect 44: The apparatus of any of aspects 41-43, where the second starting position of the second set of shaped bits, a quantity of the second set of shaped bits, the second starting position of the second set of non-shaped bits, and a quantity of the second set of non-shaped bits are associated with a redundancy version of the second instance of the data message.
Aspect 45: The apparatus of any of aspects 40-44, where the first buffer is a first circular buffer and includes a first set of information bits associated with the data message; and the second buffer is a second circular buffer and includes a second set of information bits associated with the data message and a set of parity bits.
Aspect 46: The apparatus of any of aspects 39-45, further including: means for transmitting a third instance of the data message as a second retransmission of the data message, where the third instance of the data message is associated with at least one of a third set of shaped bits or a third set of non-shaped bits, and where the third set of shaped bits and the third set of non-shaped bits are different from the second set of shaped bits and the second set of non-shaped bits, respectively.
Aspect 47: The apparatus of any of aspects 39-46, where in a constellation mapping associated with the first instance of the data message, an amplitude of the first instance of the data message is associated with the first set of shaped bits and a sign of the first instance of the data message is associated with the first set of non-shaped bits.
Aspect 48: The apparatus of any of aspects 39-47, where the first set of shaped bits and the second set of shaped bits are associated with non-uniform probability; and the first set of non-shaped bits and the second set of non-shaped bits are associated with uniform probability.
Aspect 49: An apparatus for wireless communications, including: means for receiving a first instance of a data message, where the first instance of the data message is associated with a first set of shaped bits and a first set of non-shaped bits; and means for receiving a second instance of the data message as a retransmission of the data message, where the second instance of the data message is associated with at least one of a second set of shaped bits or a second set of non-shaped bits, and where the second set of shaped bits and the second set of non-shaped bits are different from the first set of shaped bits and the first set of non-shaped bits, respectively.
Aspect 50: The apparatus of aspect 49, where the first set of shaped bits of the first instance of the data message is associated with a first starting position and an entirety of a set of multiple shaped bits and the second set of shaped bits of the second instance of the data message is associated with a second starting position and a subset of the set of multiple shaped bits; and the first set of non-shaped bits of the first instance of the data message is associated with a first starting position and a first subset of a set of multiple non-shaped bits and the second set of non-shaped bits of the second instance of the data message is associated with a second starting position and a second subset of the set of multiple non-shaped bits.
Aspect 51: The apparatus of aspect 50, further including: means for transmitting, via a control message, an indication of a coding rate and a block length for the first instance of the data message, where the second starting position of the second set of shaped bits, a quantity of the second set of shaped bits, the second starting position of the second set of non-shaped bits, and a quantity of the second set of non-shaped bits are associated with the coding rate and the block length for the first instance of the data message.
Aspect 52: The apparatus of aspect 51, where the second instance of the data message is exclusively associated with the second set of shaped bits if the coding rate is less than a threshold coding rate and the block length is greater than a threshold block length; the second instance of the data message is exclusively associated with the second set of non-shaped bits if the coding rate is greater than the threshold coding rate and the block length is less than the threshold block length; and the second instance of the data message is associated with both the second set of shaped bits and the second set of non-shaped bits otherwise.
Aspect 53: The apparatus of any of aspects 50-52, where the second starting position of the second set of shaped bits, a quantity of the second set of shaped bits, the second starting position of the second set of non-shaped bits, and a quantity of the second set of non-shaped bits are associated with a redundancy version of the second instance of the data message.
Aspect 54: The apparatus of any of aspects 50-53, where the set of multiple shaped bits is associated with a first circular buffer and includes a first set of information bits associated with the data message; and the set of multiple non-shaped bits is associated with a second circular buffer and includes a second set of information bits associated with the data message and a set of parity bits.
Aspect 55: The apparatus of any of aspects 49-54, further including: means for receiving a third instance of the data message as a second retransmission of the data message, where the third instance of the data message is associated with at least one of a third set of shaped bits or a third set of non-shaped bits, and where the third set of shaped bits and the third set of non-shaped bits are different from the second set of shaped bits and the second set of non-shaped bits, respectively.
Aspect 56: The apparatus of any of aspects 49-55, where in a constellation demapping associated with the first instance of the data message, an amplitude of the first instance of the data message is associated with the first set of shaped bits and a sign of the first instance of the data message is associated with the first set of non-shaped bits.
Aspect 57: The apparatus of any of aspects 49-56, where the first set of shaped bits and the second set of shaped bits are associated with non-uniform probability; and the first set of non-shaped bits and the second set of non-shaped bits are associated with uniform probability.
Aspect 58: A non-transitory computer-readable medium storing code for wireless communication, the code including instructions executable by a processor to: transmit a first instance of a data message, where the first instance of the data message is associated with a first set of shaped bits and a first set of non-shaped bits; and transmit a second instance of the data message as a retransmission of the data message, where the second instance of the data message is associated with at least one of a second set of shaped bits or a second set of non-shaped bits, and where the second set of shaped bits and the second set of non-shaped bits are different from the first set of shaped bits and the first set of non-shaped bits, respectively.
Aspect 59: The non-transitory computer-readable medium of aspect 58, where the first set of shaped bits of the first instance of the data message corresponds to a complete set of shaped bits from a first buffer and the second set of shaped bits of the second instance of the data message corresponds to a subset of shaped bits of the complete set of shaped bits from the first buffer; and the first set of non-shaped bits of the first instance of the data message corresponds to a first subset of non-shaped bits from a second buffer and the second set of non-shaped bits of the second instance of the data message corresponds to a second subset of non-shaped bits from the second buffer.
Aspect 60: The non-transitory computer-readable medium of aspect 59, where the first set of shaped bits is associated with a first starting position of the first buffer and the second set of shaped bits is associated with a second starting position of the first buffer; and the first set of non-shaped bits is associated with a first starting position of the second buffer and the second set of non-shaped bits is associated with a second starting position of the second buffer.
Aspect 61: The non-transitory computer-readable medium of aspect 60, where the instructions are further executable by the processor to: receive, via a control message, an indication of a coding rate and a block length for the first instance of the data message, where the second starting position of the second set of shaped bits, a quantity of the second set of shaped bits, the second starting position of the second set of non-shaped bits, and a quantity of the second set of non-shaped bits are associated with the coding rate and the block length for the first instance of the data message.
Aspect 62: The non-transitory computer-readable medium of aspect 61, where the second instance of the data message is exclusively associated with the second set of shaped bits if the coding rate is less than a threshold coding rate and the block length is greater than a threshold block length; the second instance of the data message is exclusively associated with the second set of non-shaped bits if the coding rate is greater than the threshold coding rate and the block length is less than the threshold block length; and the second instance of the data message is associated with both the second set of shaped bits and the second set of non-shaped bits otherwise.
Aspect 63: The non-transitory computer-readable medium of any of aspects 60-62, where the second starting position of the second set of shaped bits, a quantity of the second set of shaped bits, the second starting position of the second set of non-shaped bits, and a quantity of the second set of non-shaped bits are associated with a redundancy version of the second instance of the data message.
Aspect 64: The non-transitory computer-readable medium of any of aspects 59-63, where the first buffer is a first circular buffer and includes a first set of information bits associated with the data message; and the second buffer is a second circular buffer and includes a second set of information bits associated with the data message and a set of parity bits.
Aspect 65: The non-transitory computer-readable medium of any of aspects 58-64, where the instructions are further executable by the processor to: transmit a third instance of the data message as a second retransmission of the data message, where the third instance of the data message is associated with at least one of a third set of shaped bits or a third set of non-shaped bits, and where the third set of shaped bits and the third set of non-shaped bits are different from the second set of shaped bits and the second set of non-shaped bits, respectively.
Aspect 66: The non-transitory computer-readable medium of any of aspects 58-65, where in a constellation mapping associated with the first instance of the data message, an amplitude of the first instance of the data message is associated with the first set of shaped bits and a sign of the first instance of the data message is associated with the first set of non-shaped bits.
Aspect 67: The non-transitory computer-readable medium of any of aspects 58-66, where the first set of shaped bits and the second set of shaped bits are associated with non-uniform probability; and the first set of non-shaped bits and the second set of non-shaped bits are associated with uniform probability.
Aspect 68: A non-transitory computer-readable medium storing code for wireless communications, the code including instructions executable by a processor to: receive a first instance of a data message, where the first instance of the data message is associated with a first set of shaped bits and a first set of non-shaped bits; and receive a second instance of the data message as a retransmission of the data message, where the second instance of the data message is associated with at least one of a second set of shaped bits or a second set of non-shaped bits, and where the second set of shaped bits and the second set of non-shaped bits are different from the first set of shaped bits and the first set of non-shaped bits, respectively.
Aspect 69: The non-transitory computer-readable medium of aspect 68, where the first set of shaped bits of the first instance of the data message is associated with a first starting position and an entirety of a set of multiple shaped bits and the second set of shaped bits of the second instance of the data message is associated with a second starting position and a subset of the set of multiple shaped bits; and the first set of non-shaped bits of the first instance of the data message is associated with a first starting position and a first subset of a set of multiple non-shaped bits and the second set of non-shaped bits of the second instance of the data message is associated with a second starting position and a second subset of the set of multiple non-shaped bits.
Aspect 70: The non-transitory computer-readable medium of aspect 69, where the instructions are further executable by the processor to: transmit, via a control message, an indication of a coding rate and a block length for the first instance of the data message, where the second starting position of the second set of shaped bits, a quantity of the second set of shaped bits, the second starting position of the second set of non-shaped bits, and a quantity of the second set of non-shaped bits are associated with the coding rate and the block length for the first instance of the data message.
Aspect 71: The non-transitory computer-readable medium of aspect 70, where the second instance of the data message is exclusively associated with the second set of shaped bits if the coding rate is less than a threshold coding rate and the block length is greater than a threshold block length; the second instance of the data message is exclusively associated with the second set of non-shaped bits if the coding rate is greater than the threshold coding rate and the block length is less than the threshold block length; and the second instance of the data message is associated with both the second set of shaped bits and the second set of non-shaped bits otherwise.
Aspect 72: The non-transitory computer-readable medium of any of aspects 69-71, where the second starting position of the second set of shaped bits, a quantity of the second set of shaped bits, the second starting position of the second set of non-shaped bits, and a quantity of the second set of non-shaped bits are associated with a redundancy version of the second instance of the data message.
Aspect 73: The non-transitory computer-readable medium of any of aspects 69-72, where the set of multiple shaped bits is associated with a first circular buffer and includes a first set of information bits associated with the data message; and the set of multiple non-shaped bits is associated with a second circular buffer and includes a second set of information bits associated with the data message and a set of parity bits.
Aspect 74: The non-transitory computer-readable medium of any of aspects 68-73, where the instructions are further executable by the processor to: receive a third instance of the data message as a second retransmission of the data message, where the third instance of the data message is associated with at least one of a third set of shaped bits or a third set of non-shaped bits, and where the third set of shaped bits and the third set of non-shaped bits are different from the second set of shaped bits and the second set of non-shaped bits, respectively.
Aspect 75: The non-transitory computer-readable medium of any of aspects 68-74, where in a constellation demapping associated with the first instance of the data message, an amplitude of the first instance of the data message is associated with the first set of shaped bits and a sign of the first instance of the data message is associated with the first set of non-shaped bits.
Aspect 76: The non-transitory computer-readable medium of any of aspects 68-75, where the first set of shaped bits and the second set of shaped bits are associated with non-uniform probability; and the first set of non-shaped bits and the second set of non-shaped bits are associated with uniform probability.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, and the like. Also, “determining” can include receiving (such as receiving information), accessing (such as accessing data in a memory) and the like. Also, “determining” can include resolving, selecting, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or any processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, such as one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described herein as acting in some combinations and even initially claimed as such, one or more features from a claimed combination can be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described herein should not be understood as requiring such separation in all implementations, and it should be understood that the described program components and systems can generally be integrated together in a single software product or packaged into multiple software products. Additionally, other implementations are within the scope of the following claims. In some implementations, the actions recited in the claims can be performed in a different order and still achieve desirable results.

What is claimed is:

1. An apparatus for wireless communication, comprising:
an interface configured to:
output a first instance of a data message, wherein the first instance of the data message is associated with a first set of shaped bits and a first set of non-shaped bits; and
output a second instance of the data message as a retransmission of the data message, wherein the second instance of the data message is associated with at least one of a second set of shaped bits or a second set of non-shaped bits, and wherein the second set of shaped bits and the second set of non-shaped bits are different from the first set of shaped bits and the first set of non-shaped bits, respectively.

2. The apparatus of claim 1, wherein:
the first set of shaped bits of the first instance of the data message corresponds to a complete set of shaped bits from a first buffer and the second set of shaped bits of the second instance of the data message corresponds to a subset of shaped bits of the complete set of shaped bits from the first buffer; and
the first set of non-shaped bits of the first instance of the data message corresponds to a first subset of non-shaped bits from a second buffer and the second set of non-shaped bits of the second instance of the data message corresponds to a second subset of non-shaped bits from the second buffer.

3. The apparatus of claim 2, wherein:
the first set of shaped bits is associated with a first starting position of the first buffer and the second set of shaped bits is associated with a second starting position of the first buffer; and
the first set of non-shaped bits is associated with a first starting position of the second buffer and the second set of non-shaped bits is associated with a second starting position of the second buffer.

4. The apparatus of claim 3, wherein the interface is further configured to:
obtain, via a control message, an indication of a coding rate and a block length for the first instance of the data message, wherein the second starting position of the second set of shaped bits, a quantity of the second set of shaped bits, the second starting position of the second set of non-shaped bits, and a quantity of the second set of non-shaped bits are associated with the coding rate and the block length for the first instance of the data message.

5. The apparatus of claim 4, wherein:
the second instance of the data message is exclusively associated with the second set of shaped bits if the coding rate is less than a threshold coding rate and the block length is greater than a threshold block length;
the second instance of the data message is exclusively associated with the second set of non-shaped bits if the coding rate is greater than the threshold coding rate and the block length is less than the threshold block length; and
the second instance of the data message is associated with both the second set of shaped bits and the second set of non-shaped bits otherwise.

6. The apparatus of claim 3, wherein the second starting position of the second set of shaped bits, a quantity of the second set of shaped bits, the second starting position of the second set of non-shaped bits, and a quantity of the second set of non-shaped bits are associated with a redundancy version of the second instance of the data message.

7. The apparatus of claim 2, wherein:
the first buffer is a first circular buffer and includes a first set of information bits associated with the data message; and
the second buffer is a second circular buffer and includes a second set of information bits associated with the data message and a set of parity bits.

8. The apparatus of claim 1, wherein the interface is further configured to:
output a third instance of the data message as a second retransmission of the data message, wherein the third instance of the data message is associated with at least one of a third set of shaped bits or a third set of non-shaped bits, and wherein the third set of shaped bits and the third set of non-shaped bits are different from the second set of shaped bits and the second set of non-shaped bits, respectively.

9. The apparatus of claim 1, wherein in a constellation mapping associated with the first instance of the data message, an amplitude of the first instance of the data message is associated with the first set of shaped bits and a sign of the first instance of the data message is associated with the first set of non-shaped bits.

10. The apparatus of claim 1, wherein:
the first set of shaped bits and the second set of shaped bits are associated with non-uniform probability; and
the first set of non-shaped bits and the second set of non-shaped bits are associated with uniform probability.

11. An apparatus for wireless communications, comprising:
an interface configured to:
obtain a first instance of a data message, wherein the first instance of the data message is associated with a first set of shaped bits and a first set of non-shaped bits; and
obtain a second instance of the data message as a retransmission of the data message, wherein the second instance of the data message is associated with at least one of a second set of shaped bits or a second set of non-shaped bits, and wherein the second set of shaped bits and the second set of non-shaped bits are different from the first set of shaped bits and the first set of non-shaped bits, respectively.

12. The apparatus of claim 11, wherein:
the first set of shaped bits of the first instance of the data message is associated with a first starting position and an entirety of a plurality of shaped bits and the second set of shaped bits of the second instance of the data message is associated with a second starting position and a subset of the plurality of shaped bits; and
the first set of non-shaped bits of the first instance of the data message is associated with a first starting position and a first subset of a plurality of non-shaped bits and the second set of non-shaped bits of the second instance of the data message is associated with a second starting position and a second subset of the plurality of non-shaped bits.

13. The apparatus of claim 12, wherein the interface is further configured to:
output, via a control message, an indication of a coding rate and a block length for the first instance of the data message, wherein the second starting position of the second set of shaped bits, a quantity of the second set of shaped bits, the second starting position of the second set of non-shaped bits, and a quantity of the second set of non-shaped bits are associated with the coding rate and the block length for the first instance of the data message.

14. The apparatus of claim 13, wherein:
the second instance of the data message is exclusively associated with the second set of shaped bits if the coding rate is less than a threshold coding rate and the block length is greater than a threshold block length;
the second instance of the data message is exclusively associated with the second set of non-shaped bits if the coding rate is greater than the threshold coding rate and the block length is less than the threshold block length; and
the second instance of the data message is associated with both the second set of shaped bits and the second set of non-shaped bits otherwise.

15. The apparatus of claim 12, wherein the second starting position of the second set of shaped bits, a quantity of the second set of shaped bits, the second starting position of the second set of non-shaped bits, and a quantity of the second set of non-shaped bits are associated with a redundancy version of the second instance of the data message.

16. The apparatus of claim 12, wherein:
the plurality of shaped bits is associated with a first circular buffer and includes a first set of information bits associated with the data message; and
the plurality of non-shaped bits is associated with a second circular buffer and includes a second set of information bits associated with the data message and a set of parity bits.

17. The apparatus of claim 11, wherein the interface is further configured to:
obtain a third instance of the data message as a second retransmission of the data message, wherein the third instance of the data message is associated with at least one of a third set of shaped bits or a third set of non-shaped bits, and wherein the third set of shaped bits and the third set of non-shaped bits are different from the second set of shaped bits and the second set of non-shaped bits, respectively.

18. The apparatus of claim 11, wherein in a constellation demapping associated with the first instance of the data message, an amplitude of the first instance of the data message is associated with the first set of shaped bits and a sign of the first instance of the data message is associated with the first set of non-shaped bits.

19. The apparatus of claim 11, wherein:
the first set of shaped bits and the second set of shaped bits are associated with non-uniform probability; and
the first set of non-shaped bits and the second set of non-shaped bits are associated with uniform probability.

20. A method for wireless communication, comprising:
transmitting a first instance of a data message, wherein the first instance of the data message is associated with a first set of shaped bits and a first set of non-shaped bits; and
transmitting a second instance of the data message as a retransmission of the data message, wherein the second instance of the data message is associated with at least one of a second set of shaped bits or a second set of non-shaped bits, and wherein the second set of shaped bits and the second set of non-shaped bits are different from the first set of shaped bits and the first set of non-shaped bits, respectively.

21. The method of claim 20, wherein:
the first set of shaped bits of the first instance of the data message corresponds to a complete set of shaped bits from a first buffer and the second set of shaped bits of the second instance of the data message corresponds to a subset of shaped bits of the complete set of shaped bits from the first buffer; and
the first set of non-shaped bits of the first instance of the data message corresponds to a first subset of non-shaped bits from a second buffer and the second set of non-shaped bits of the second instance of the data message corresponds to a second subset of non-shaped bits from the second buffer.

22. The method of claim 21, wherein:
the first set of shaped bits is associated with a first starting position of the first buffer and the second set of shaped bits is associated with a second starting position of the first buffer; and
the first set of non-shaped bits is associated with a first starting position of the second buffer and the second set of non-shaped bits is associated with a second starting position of the second buffer.

23. The method of claim 22, further comprising:
receiving, via a control message, an indication of a coding rate and a block length for the first instance of the data message, wherein the second starting position of the second set of shaped bits, a quantity of the second set of shaped bits, the second starting position of the second set of non-shaped bits, and a quantity of the second set of non-shaped bits are associated with the coding rate and the block length for the first instance of the data message.

24. The method of claim 23, wherein:
the second instance of the data message is exclusively associated with the second set of shaped bits if the coding rate is less than a threshold coding rate and the block length is greater than a threshold block length;
the second instance of the data message is exclusively associated with the second set of non-shaped bits if the coding rate is greater than the threshold coding rate and the block length is less than the threshold block length; and
the second instance of the data message is associated with both the second set of shaped bits and the second set of non-shaped bits otherwise.

25. The method of claim 22, wherein the second starting position of the second set of shaped bits, a quantity of the second set of shaped bits, the second starting position of the second set of non-shaped bits, and a quantity of the second set of non-shaped bits are associated with a redundancy version of the second instance of the data message.

26. A method for wireless communications, comprising:
receiving a first instance of a data message, wherein the first instance of the data message is associated with a first set of shaped bits and a first set of non-shaped bits; and
receiving a second instance of the data message as a retransmission of the data message, wherein the second instance of the data message is associated with at least one of a second set of shaped bits or a second set of non-shaped bits, and wherein the second set of shaped bits and the second set of non-shaped bits are different from the first set of shaped bits and the first set of non-shaped bits, respectively.

27. The method of claim 26, wherein:
the first set of shaped bits of the first instance of the data message is associated with a first starting position and an entirety of a plurality of shaped bits and the second set of shaped bits of the second instance of the data message is associated with a second starting position and a subset of the plurality of shaped bits; and
the first set of non-shaped bits of the first instance of the data message is associated with a first starting position and a first subset of a plurality of non-shaped bits and the second set of non-shaped bits of the second instance of the data message is associated with a second starting position and a second subset of the plurality of non-shaped bits.

28. The method of claim 27, further comprising:
transmitting, via a control message, an indication of a coding rate and a block length for the first instance of the data message, wherein the second starting position of the second set of shaped bits, a quantity of the second set of shaped bits, the second starting position of the second set of non-shaped bits, and a quantity of the second set of non-shaped bits are associated with the coding rate and the block length for the first instance of the data message.

29. The method of claim 28, wherein:
the second instance of the data message is exclusively associated with the second set of shaped bits if the coding rate is less than a threshold coding rate and the block length is greater than a threshold block length;
the second instance of the data message is exclusively associated with the second set of non-shaped bits if the coding rate is greater than the threshold coding rate and the block length is less than the threshold block length; and
the second instance of the data message is associated with both the second set of shaped bits and the second set of non-shaped bits otherwise.

30. The method of claim 27, wherein the second starting position of the second set of shaped bits, a quantity of the second set of shaped bits, the second starting position of the second set of non-shaped bits, and a quantity of the second set of non-shaped bits are associated with a redundancy version of the second instance of the data message.
